(19) United States
(12) Patent Application Publication
(10) Pub. No.: US 2019/0389775 A1
(43) Pub. Date: Dec. 26, 2019

(54) SURFACE EFFECT POLYMER DERIVED CERAMICS, METHODS, MATERIALS AND USES

(71) Applicant: Melior Innovations, Inc., Houston, TX (US)

(72) Inventors: Liao P Wen, Clifton Park, NY (US); Andrew R Hopkins, Houston, TX (US); Douglaws M Dukes, Troy, NY (US); Richard Landtiser, Naperville, IL (US); David Bening, Columbus, OH (US)

(73) Assignee: Melior Innovations, Inc., Houston, TX (US)

(21) Appl. No.: 16/331,789

(22) PCT Filed: Sep. 8, 2017
(86) PCT No.: PCT/US2017/050780

§ 371 Date: Mar. 8, 2019

Related U.S. Application Data
(63) Continuation-in-part of application No. 15/699,732, filed on Sep. 8, 2017.
Application No. 15/699,732 is a continuation-in-part of application No. 14/634,819, filed on Feb. 28, 2015.
(60) Provisional application No. 62/385,821, filed on Sep. 9, 2016.

(51) Int. Cl. C04B 35/571; C04B 35/626; C04B 35/628; C04B 37/00; C09D 183/04; C09D 7/41; C09D 5/36

(52) U.S. Cl. CPC C04B 35/571; C04B 2237/365; C04B 35/6269; C04B 35/62821; C04B 35/62826; C04B 35/62894; C04B 35/62897; C04B 37/001; C09D 183/04; C09D 7/41; C09D 5/36; C04B 2235/401; C04B 2235/402; C04B 2235/404; C04B 2235/405; C04B 2237/341; C04B 2237/343; C04B 35/6267

(57) ABSTRACT

A polysilocarb effect pigments, uncoated and coated, that exhibit among other things optical properties such as interference, shine, shimmer and sparkle. Pastes and coating including these polysilocarb effect pigments. Polysilocarb pigments having magnetite and exhibiting magnetic properties.

This application claims under 35 U.S.C. § 119(e)(1) the benefit of U.S. provisional application Ser. No. 62/385,821, filed Sep. 9, 2016, the entire disclosure of which is incorporated herein by reference.

### BACKGROUND OF THE INVENTION

### Field of the Invention

The present inventions relate to surface properties and effects on compositions, structures and materials; polymer derived ceramic materials; and in particular, polysilocarb compositions, structures and materials. The present inventions further relate to surface layers and surface compositions that provide specialty features and functionality, including optical, magnetic, electrical, and hydrophilicity-hydrophobicity, and methods for obtaining these surfaces

The present inventions further relate to these materials, and in particular, these silicon, carbon and oxygen containing ceramic materials, which may be black or other colors, and that exhibit optical properties, in addition to absorption, and in particular, and preferably, exhibit optical properties, such as: refraction, reflection, transmission, wavelength specific absorption, polarization, and combinations and various of these and other optical properties, as well as, interference, amplification and cancellation.

Generally, the art classifies pigments into three typical pigment types: absorption pigments, metal effect pigments and pearlescent pigments. While these are general classifications, it should be understood that other classifications, and types may be used to describe pigments, and their optical properties in a coating. There also may be variations and combinations of these, and other types or classifications of pigments in a coating.

Absorption pigments, which are illustrated in the schematic of FIG. 1A, are for example watercolor paints. They absorb part of the light which hits them and scatter the rest, giving them their own body color. Thus, as shown in FIG. A a coating 100 on a substrate 102 has absorption pigments 103, 104, 105, 106. As light rays 107, 108, 109, 110 strike the pigments 103, 104, 105, 106 a range of the lights wavelengths are absorbed by the pigment and the remaining wavelengths are scattered. Typically, absorption pigments exhibit two primary optical properties, wavelength specific absorption and scatter.

Generally, metal effect pigments pigments, which are illustrated in the schematic of FIG. 1B, redirect, e.g., reflect, the vast majority of the light that strikes them, e.g., in a manner similar to a tiny mirror. Thus, as shown in FIG. 1B a coating 110 on a substrate 112 has metal effect pigments 103, 104, 105. As light rays 106, 107, 108 strike the pigments 103, 104, 105 they are reflected and, typically exit back out through the coating surface. In this manner, these metal effect pigments give the coating, and thus the substrate, a surface luster, twinkle, dazzle, etc. Typically, metal effect pigments exhibit one primary optical property, reflectance.

Pearlescent pigments, which are illustrated in the schematic of FIG. 1C, exhibit multiple and varied optical properties. In some embodiments they can be view as a combination metal effect pigments and absorption pigments, in others they have more complex and varied optical properties. Thus, as shown in FIG. 1C, a coating 120 on a substrate 122 has pearlescent effect pigments 123, 124, 125, 126. Although not shown in the schematic of FIG. 1C, pearlescent effect pigments typically have multi-layer structures. Thus, as light rays 127, 128, 129 strike and enter the pearlescent effect pigment 123, 124, 125, 126, the rays are refracted, reflected and transmitted, resulting generally in a complex pattern of rays (including various polarizations and wavelengths, as well as interference, amplification and cancellation) exiting the coating. Thus, typically pearlescent effect pigments exhibit a complex combination of multiple optical properties, e.g., refraction, reflection, polarization, absorption and wave combining effect (e.g., interference, amplification and cancellation). This complex ray pattern gives the coating, and thus the substrate, the unique brilliance, pop, shimmer, etc., that make pearlescent effect pigments in certain applications highly desirable.

In general, in should be understood that FIGS. 1A, 1B and 1C are schematic illustrations, and simplifications. The various types of pigments generally will be at much higher loadings, e.g., larger numbers present, and may be evenly suspended through the coating, or maybe stratified, e.g., all near the surface of the coating, the surface of the substrate and other variations and combinations. Generally, metal oxides are coated on a pigment body to produce an effect pigment. Typically, a wide variety of effects can be achieved, from matte shimmer similar to that of pearl or mother of pearl to interference looks with significant shimmer in many colors, as well as other and additional features and effects.

As used herein, unless stated otherwise, the terms “effect”, “effects”, “effect layer”, “effects layer”, “effect pigment”, “effects pigment”, and similar such terms shall be given their broadest possible meaning, and would include pearlescent effect pigments, metal effect pigments, vacuum-metallized aluminum pigment, cornflake-type, plate-like, lamellar, non-leafing aluminum flakes, mica-based pigments, high-chromaticity effect pigments, lamellar effect pigments and. The term effect pigments would include commercially available pigments, and pigments providing the features and optical effects of these commercially available pigments such as, for example: BASF Black Olive™ Dynacolor® pigments, Firemist® pigments, Glacier™ Frost White, Graphitan® graphite black pigment, and Lumina® pigments. In general effects pigments can recreate visual effects that are described by those of skill in the art, for example, as: providing interference effects for all color spaces; the creation of effects shades and extreme effect shades; the creation of optical effects and extraordinary optical effects ranging from a fine-grained luster to a bold silvery-white sparkle; effects from a soft, satin luster to a sharp, metallic brilliance; hiding power; gloss; chroma; and, as well as combinations and variations of these and other optical features and properties.

As used herein, unless stated otherwise, the terms “color,” “colors” “coloring” and similar such terms are be given their broadest possible meaning and would include, among other things, the appearance of the object or material, the color imparted to an object or material by an additive, methods of changing, modifying or affecting color, the reflected refracted and transmitted wavelength(s) of light detected or observed from an object or material, the reflected refracted and transmitted spectrum(s) of light detected or observed from an object or material, all colors, e.g. white, grey, black, red, violet, amber, almond, orange, aquamarine, tan, forest green, etc., primary colors, secondary colors, and all variations between, and the characteristic of light by which any two structure free fields of view of the same size and shape can be distinguish between.

As used herein, unless stated otherwise, the term “gloss” is to be given its broadest possible meaning, and would include the appearance from specular reflection. Generally, the reflection at the specular angle is the greatest amount of light reflected for any specific angle. In general, glossy surfaces appear darker and more chromatic, while matte surfaces appear lighter and less chromatic.

As used herein, unless stated otherwise, the terms “visual light,” “visual light source,” “visual spectrum” and similar such terms refers to light having a wavelength that is visible, e.g., perceptible, to the human eye, and includes light generally in the wave length of about 390 nm to about 770 nm, and in particular about 400 nm to about 700 nm.

As used herein, unless stated otherwise, the term “coating” is to be given its broadest possible meaning, and would include among other things, the act of applying a thin layer to a substrate, any material that is applied as a layer, film, or thin covering (partial or total) to a surface of a substrate, and includes inks, paints, and adhesives, powder coatings, foam coatings, liquid coatings, and includes the thin layer that is formed on the substrate.

As used herein, unless stated otherwise, the term “sparkle” is to be given its broadest possible meaning, and would include among other things, multi angle reflections simultaneously imparted from the surface facets.

As used herein, unless stated otherwise, room temperature is 25° C. And, standard ambient temperature and pressure is 25° C. and 1 atmosphere. Unless expressly stated otherwise all tests, test results, physical properties, and values that are temperature dependent, pressure dependent, or both, are provided at standard ambient temperature and pressure, this would include viscosities.

Generally, the term “about” as used herein unless stated otherwise is meant to encompass a variance or range of ±10%, the experimental or instrument error associated with obtaining the stated value, and preferably the larger of these.

As used herein, unless specified otherwise the terms %, weight % and mass % are used interchangeably and refer to the weight of a first component as a percentage of the weight of the total, e.g., formulation, mixture, preform, material, structure or product. The usage X/Y or XY indicates weight % of X and the weight % of Y in the formulation, unless expressly provided otherwise. The usage X/Y/Z or XYZ indicates the weight % of X, weight % of Y and weight % of Z in the formulation, unless expressly provided otherwise.

As used herein, unless specified otherwise “volume %” and “% volume” and similar such terms refer to the volume of a first component as a percentage of the volume of the total, e.g., formulation, mixture, preform, material, structure or product.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

Accordingly, there has been a long-standing and increasing need for new pigments, additives and particles that have specialty features and effects. The present inventions, among other things, solves these needs by providing the materials, compositions, and methods taught herein.

There is provided a polysicocarb ceramic effects pigment, and methods of making such effect pigment, the pigment having: an effect layer, a polysilocarb derived ceramic base and an optical interface between the effect layer and the polysilocarb derived ceramic base; the effect layer defining a thickness, a reflective effect, and a refractive effect, wherein the reflective effect and refractive effect are different; the polysilocarb derived ceramic base consisting essentially of carbon, oxygen and silicon (e.g., there are no other materials effecting the optical properties of the base present); the polysicocarb derived ceramic base defining a thickness, an absorption coefficient, and a percentage light absorption; wherein the refractive effect interacts across the optical interface with the polysilocarb base to define a secondary reflective effect.

Further there is provided these pigments and methods having one or more of the following features: wherein the secondary reflective effect is predetermined and controlled based in part upon the carbon content of the base; wherein the absorption coefficient of the base is from about 1,000 to about 20,000 1/cm; wherein the absorption coefficient of the base is from about 5,000 to about 15,000 1/cm; wherein the thickness of the base is from about 0.2 μm to about 2 μm; wherein the thickness of the base is from about 0.5 μm to about 2.5 μm; wherein the thickness of the base is from about 0.5 μm to about 2.5 μm; wherein the base has a percentage light absorption from about 40% to about 100%; wherein the base has a percentage light absorption from about 50% to about 90%; wherein the base has a percentage light absorption from about 60% to about 80%; wherein the base has a percentage light absorption from about 60% to about 98%; wherein the base has a percentage light absorption from about 40% to about 100%; wherein the base has a percentage light absorption from about 50% to about 90%; wherein the effect layer has a material selected from the group consisting of SiO₂, TiO₂, FeO₂, Fe₂O₃, Fe₃O₄, Cr₂O₂, and (Sn, Sb)O₂; wherein the reflective effect has an effect selected from the group consisting of pearl, gold, red, green and blue; wherein the refractive effect has an effect selected from the group consisting of white, gold, red, green and blue; wherein the effect layer is a coating on the base; wherein the effect layer is integral with the base; wherein the secondary reflective effect is selected from the group consisting of pearl, gold, red, green and blue; wherein the secondary reflective effect is selected from the group consisting of pearl, gold, red, green and blue; and wherein the base is free from B, Al, K, Na, Ca, Mg, Fe, Mn, Cr, Ti, Li, Ba, Rb, and Cs.

Still further there is provide a polysicocarb ceramic magnetic effects pigment, and methods of making this pigment, the pigment having: an effect layer, a polysilocarb derived ceramic base and an optical interface between the effect layer and the polysilocarb derived ceramic base; the effect layer defining a thickness, a reflective effect, and a refractive effect, wherein the reflective effect and refractive effect are different; the polysilocarb derived ceramic base having magnetite, carbon, oxygen and silicon; the polysicocarb derived ceramic base defining a thickness, an absorption coefficient, and a percentage light absorption; wherein the refractive effect interacts across the optical interface with the polysilocarb base to define a secondary reflective effect.

Furthermore, there is provide a polysicocarb ceramic magnetic effects pigment, the pigment having: a polysilocarb derived ceramic base; the polysilocarb derived ceramic base consisting essentially of magnetite, carbon, oxygen and silicon; and, the polysicocarb derived ceramic base defining a thickness, an absorption coefficient, and a percentage light absorption.

Moreover, there is provided a polysicocarb ceramic effects pigment, the pigment having: an effect layer, a polysilocarb derived ceramic base and an optical interface between the effect layer and the polysilocarb derived ceramic base; the effect layer defining a thickness, a reflective effect, and a refractive effect, wherein the reflective effect and refractive effect are different; the effect layer having a material selected from the group consisting of SiO₂, TiO₂, FeO₂, Fe₂O₃, Fe₃O₄, Cr₂O₂, and (Sn, Sb)O₂; the polysilocarb derived ceramic base having carbon, oxygen and silicon; the polysicocarb derived ceramic base defining a thickness, an absorption coefficient, and a percentage light absorption; wherein the absorption coefficient is from about 5,000 to about 20,000 1/cm, and the thickness is from about 0.5 μm to about 2.5 μm; and wherein the refractive effect interacts across the optical interface with the polysilocarb base to define a secondary reflective effect.

Yet further there is provide a method of method of making the effects pigment of claim 1, including the steps for forming a ceramic base and the steps for forming an effect layer on the ceramic base (which method steps are provided in this specification).

Additionally, there is provided the method of making a magnetic ceramic material including the steps of: making a polysilocarb precursor liquid formulation, the liquid formulation including magnetite, curing the liquid formulation to form a cured polysilocarb solid; wherein the cured solid contains magnetite, whereby the cured solid exhibits magnetic properties.

Yet additionally, there is provided these methods having the following feature or property: including pyrolizing the cured solid to form a polysilocarb ceramic; wherein the ceramic contains magnetite, whereby the ceramic exhibits magnetic properties.

### BRIEF DESCRIPTION OF THE DRAWINGS

FIG. 1A is a schematic representation of the optical properties of a coating having absorption pigments.

FIG. 1B is a schematic representation of the optical properties of a coating have metal effects pigments.

FIG. 1C is a schematic representation of the optical properties of a coating having pearlescent effects pigments.

FIG. 2 is a schematic cross section of an embodiment of an effects pigment in accordance with the present inventions.

FIG. 3A is a cross sectional schematic view of an embodiment of a system for magnetically orienting effects pigments in a coating in accordance with the present inventions.

FIG. 3B is an SEPM of an embodiment of a magnetic effects pigment in accordance with the present inventions (scale bar 100 μm, 610x, 5 kV).

FIG. 3C is is an SEPM of an embodiment of a magnetic effects pigment in accordance with the present inventions (scale bar 100 μm, 830x, 15 kV).

FIG. 3D is a perspective view, photograph, of a polymer derived ceramic magnetic material in accordance with the present inventions.

FIG. 4 is a schematic illustration on the relationship between thickness and optical or visual effect in accordance with the present inventions.

FIG. 5 is a graph showing the absorption vs thickness of polysilocarb effect pigment bases, for embodiments having different polysilocarb formulations, in accordance with the present inventions.

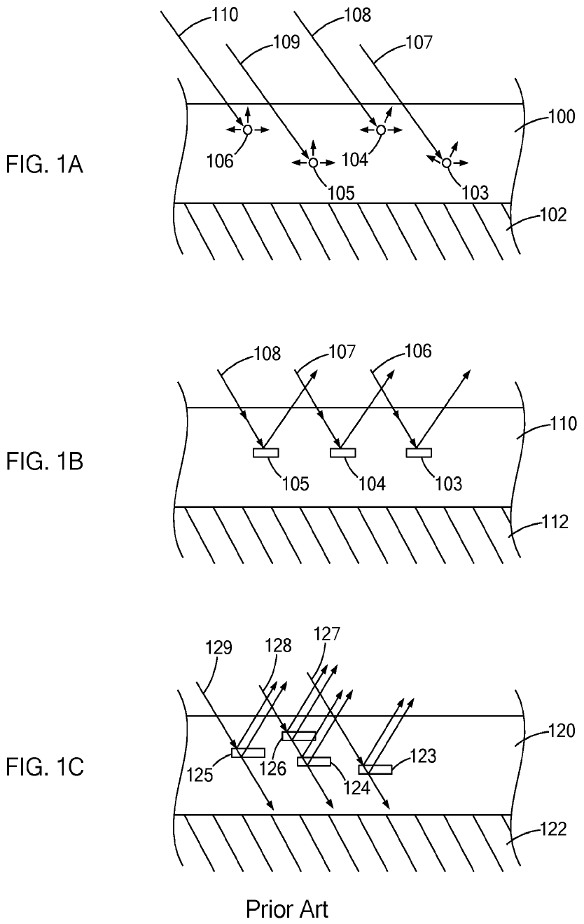

### DESCRIPTION OF THE PREFERRED EMBODIMENTS

In general, the present inventions relate to unique and novel silicon (Si) based materials, including polyorganic materials that contain silicon, that are typically and preferably easy to manufacture, handle and have surprising and unexpected properties and applications. In particular, these materials provide a substrate for specialty layers and surface compositions that provide unique and important surface effects, such as electro-magnetic properties (e.g., extending above and below visible wavelengths of about 400 nm to about 700 nm), magnetism, conductivity, resistivity, optical properties, e.g., color, reflectance, lustier, selective absorption, shine, interference, refraction, reflection, hydrophobicity and hydrophilicity. As a cured material (e.g., a plastic), a preceramic, and a pyrolized material (e.g., a ceramic), these surface effect silicon based materials have applications and utilizations, in and as, pigments, paints, inks, coatings, adhesives, electronics, military, marine, medical, power storage, and batteries, to name a few.

The surface effects that can come from specialty layers and surface compositions can be integral with, or added onto a substrate or base material. In embodiments, the base material is a polymer derived ceramic (“PDC”) material, in either its ceramic or cured state.

In a preferred embodiment of the present inventions the base material is a PDCs that is a “polysilocarb” material, e.g., a material containing silicon (Si), oxygen (O) and carbon (C), in its solid cured state, and more preferably, in its ceramic state after it has been pyrolized.

The polysilocarb base materials may also contain other elements. Polysilocarb materials are made from one or more polysilocarb precursor formulation or precursor formulation. The polysilocarb precursor formulation contains one or more functionalized silicon polymers, or monomers, non-silicon based cross linkers, as well as, potentially other ingredients, such as for example, inhibitors, catalysts, fillers, dopants, modifiers, initiators, reinforcers, fibers, particles, colorants, pigments, dies, the same or other PDCs, ceramics, metals, metal complexes, and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, ceramic materials, and combinations and variations of these.

Examples of PDCs, PDC formulations, potential precursors, starting materials, and apparatus and methods for making these materials, that can be used, or adapted and improved upon employing the teachings of this specification to be used, in embodiments of the present inventions are found, for example, in US Patent Publication Nos. 2014/0274658, 2014/0323364, 2015/0175750, 2016/0207782, 2016/0280607, 2017/0050337, 2008/0095942, 2008/0093185, 2007/0292690, 2006/0069176, 2006/0004169, and 2005/0276961, and U.S. Pat. Nos. 9,499,677, 9,481,781, 8,742,008, 8,119,057, 7,714,092, 7,087,656, 5,153,295, and 4,657,991, and the entire disclosures of each of which are incorporated herein by reference.

Generally, the liquid polysilocarb precursor formulation is cured to form a solid or semi-sold material, e.g., cured material, green material, or plastic material. This material may be further cured, under predetermined conditions. The material may also be pyrolized under predetermined conditions to form a ceramic material. These processing conditions, and the particular formulations, can typically, contribute to the performance, features and properties of the end product or material. Typically, inhibitors and catalysis, as well as, or in addition to the selection of curing conditions, may be used to determine, contribute to, or otherwise affect, processing conditions, as well as, end properties of the material.

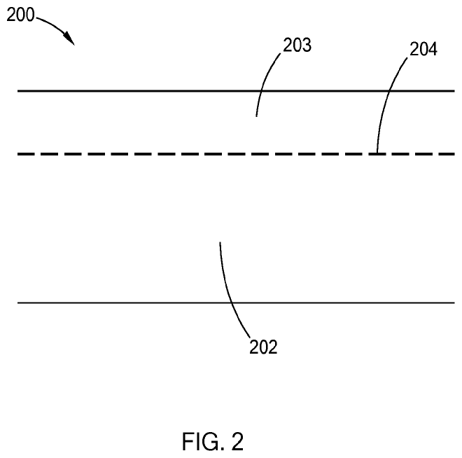

Turning to FIG. 2 there is a cross section schematic of an embodiment of an effects pigment of the present invention. The surface effect PDC 200 has a base or substrate 202. The base has an effects layer 203. The effects layer can be integral with the base 202, i.e., is made with the base material, or it can be added on after the base is made. It being understood that the effects layer 203, can be on the top surface (as shown in the figure), the bottom, one or more sides, partially or entirely encompassing the base, and combinations and variations of these. In this manner, the effects layer itself becomes the top, or outer layer of the effect pigment.

The transition or interface 204 between the effects layer 203 and the base or substrate 202, creates an optical interface that results in optical effects, including for example reflection and refraction, based upon the respective optical properties of the layer 203 and the base 202 provides for predetermined, controlled and unique optical effects.

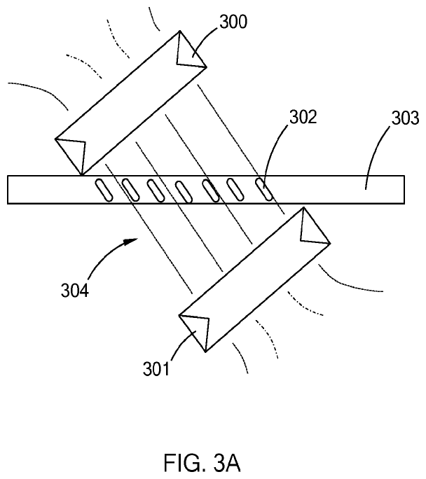

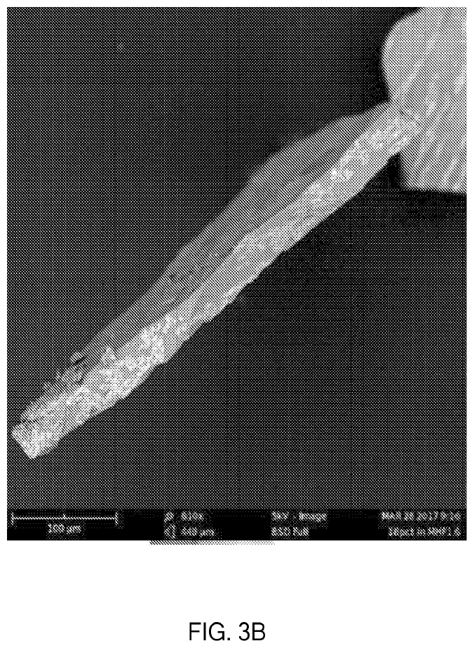

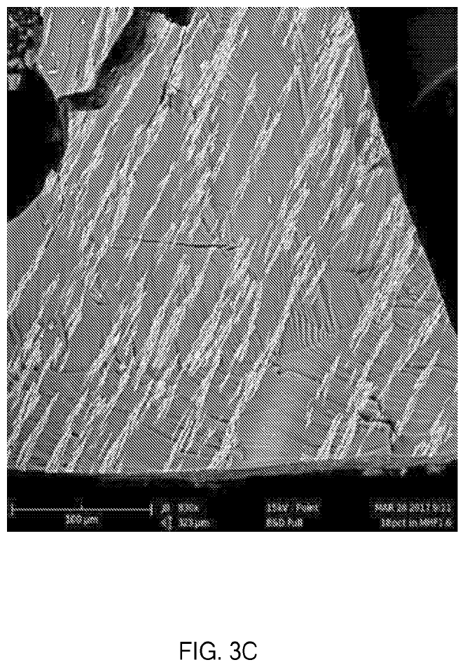

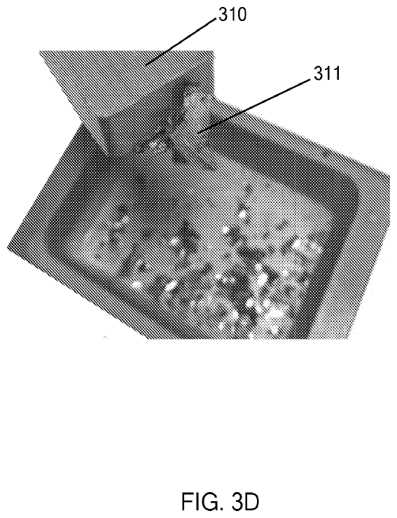

Turning to FIG. 3A there is shown a schematic of a layer 303 having a magnetic effects pigments, e.g., 302, located and orientated within layer 303. The magnetic effects pigments, e.g., 302, are subjected to a magnetic field 304 by magnets 300 and 301. It being understood that the use of magnetic fields to orient magnetic flakes can provide many different and dynamic optical effects and other properties. The flakes can be arranged in manners that could provide of the absorbance, reflectance or transmission of different wavelengths in the electromagnetic spectrum (e.g., light as well as, wavelengths above and below visible light and above and below light). The layer 303 can be a coating and can be set, in which manner the orientation of the flakes is frozen, e.g., held or fixed. The layer 303 can be dynamic, in which instance the flakes can move or change orientation, based upon the nature of the magnetic field they are subjected to.

FIGS. 3B and 3C are SEPM of magnetic effects pigments made in accordance with Example 23. FIG. 3D illustrates ceramic magnetic effect polymer derived ceramic material 311 attached to magnet 210. The magnetic effect or feature of the material can be used for the purposes of manufacturing.

The magnetic properties of the material are present in both the cured and pyrolized, i.e., ceramic states. Thus, there is a magnetic polysilocarb cured plastic; and there is a magnetic polysilocarb pyrolized ceramic. The magnetic property of the material can be used for manufacturing purposes, handling purposes, distribution purposes, packaging and unpacking purposes use purposes and other purposes and applications. Thus, and by way of illustration, the magnetic property can be used to remove the material from a substrate, can be used to collect the material from a liquid, can be used in transferring the material, can be used to remove the material from a recycle stream, can be used to isolate the material from another (non-magnetic), and can be used in any manner where magnetism and magnetic properties are used manufacturing processes and applications.

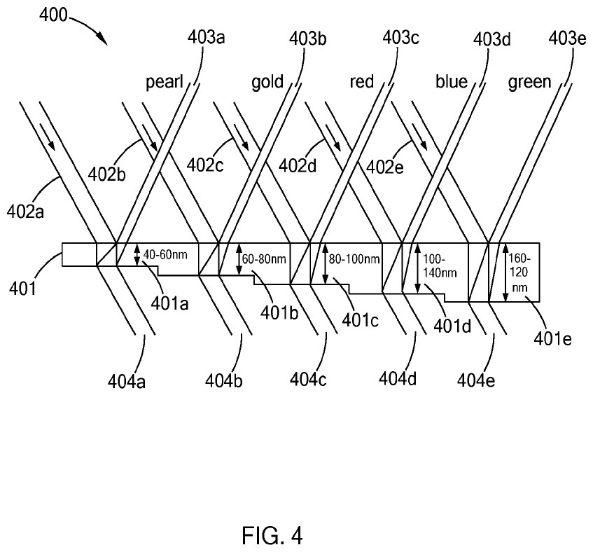

Turning to FIG. 4 is a cross section schematic illustrating the effect of thickness on the visual optical effects as they relate to thickness of an effects layer of an effects pigment. This figure is for illustrative purposes, as these effects based upon thickness may vary depending upon several factors, including the type of effects layer and the formulation of polysilocarb material used to make the base of the effects pigment. White light 402a, 402b, 402c, 402d, 402e (sub-letters a, b, c, d, e, respectively refer to effects from the respective thicknesses) enters effects layer 401 having a thickness 401a (40-60 nm), 401b (60-80 nm), 401c (80-100 nm), 401d (100-140 nm), 401e (120-160 nm). (The base or substrate under the effects layer is not shown in this figure.) The white light is reflected as different effects (i.e., reflected effect) based on thickness, 403a pearl, 403b gold, 403c red, 403d blue, 403e green, and refracted as different effects (i.e., refracted effect) based upon thickness, 404a white, 404b blue, 404c green, 404d yellow, 404e red. It being understood that the refracted light would then further interact with the polysilocarb substrate or base, which is not shown in this figure.

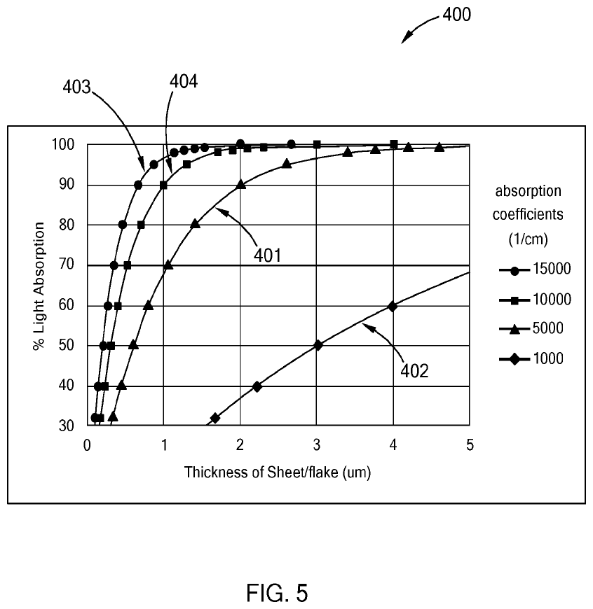

Turning to FIG. 5, there is provided a chart 400 illustrating an example of the relationship of the effects of thickness and the formulation of the polysilocarb material has on the opacity and light absorption of the base or substrate layer of the polysilocarb effects pigment. Line 402 is for a polysilocarb base having an absorption coefficient of 1,000 1/cm. It is theorized that as carbon content in the polysilocarb base increases, its light absorption will increase (i.e., it will become less transparent). Line 401 is for a polysilocarb base derived from an 85:15 (MHF:DCPD) formulation and has an absorption coefficient of 5,000 1/cm. Line 404 is for polysilocarb base having an absorption coefficient of 10,000 1/cm. Line 403 is for a polysilocarb base having an absorption coefficient of 15,000 1/cm (which theoretically can be obtained from a 50:50 MHF:DCPD formulation).

Thus, considering FIG. 4 (the features and properties of the effects layer) and FIG. 5 (the features and properties of the base) together, (e.g., along an interface between those structures, for example the optical interface 204 as shown in FIG. 2), the present inventions provide the unique, and never before known property and feature, of having an effects pigment having an optically active interface between (i) a base having a predetermined and controlled light absorption, and a predetermined and controlled thickness, and (ii) an effects layer having a predetermined and controlled reflective effect (e.g., 403b) and refractive effect (e.g., 404b) (as illustrated in FIG. 4).

Generally, the base can be any volumetric shape, such as, beads, pucks, pellets, spheres, platelets, and particles. These volumetric shapes would also include, for example, lenses, disks, panels, cones, frustoconical shapes, squares, rectangles, trusses, angles, silver dollar, channels, hollow sealed chambers, hollow spheres, blocks, sheets, coatings, films, skins, particulates, beams, rods, angles, columns, fibers, staple fibers, tubes, cups, pipes, and combinations and various of these and other more complex shapes, both engineering and architectural.

In conventional effects pigments the base can be mica flakes, bismuth oxychloride flakes, borosilicate flakes, and alumina flakes, by way of example. These conventional base materials are typically, if not exclusively transparent. These conventional base materials, both natural and synthetic generally, if not always, also contain other elements beside silicon, such as B, Al, K, Na, Ca, Mg, Fe, Mn, Cr, Ti, Li, Ba, Rb, and Cs. These other elements to greater or lessor extents are undesirable, as they can be hazardous heavy metals, and can interfere with the application and performance of the effects layer.

The present effect pigments, are based upon an SiOC base material. Embodiments of base material can be “free from”, i.e., having less than 0.001%, 1 ppm, (in total) of these other elements (B, Al, K, Na, Ca, Mg, Fe, Mn, Cr, Ti, Li, Ba, Rb, and Cs). The base material can be 6-nines pure SiOC (i.e., 99.9999% of the base material consists of SiOC), or of greater purity. Embodiments of base material can have less than 0.001%, 1 ppm, (individually) of these other elements. Embodiments of base material can have less than 0.001%, 10 ppm, (in total) of these other elements (B, Al, K, Na, Ca, Mg, Fe, Mn, Cr, Ti, Li, Ba, Rb, and Cs). The base material can be 5-nines pure SiOC (i.e., 99.999% of the base material consists of SiOC). Embodiments of base material can have less than 0.001%, 100 ppm, (individually) of these other elements. Embodiments of base material can have less than 0.01%, 100 ppm, (in total) of these other elements (B, Al, K, Na, Ca, Mg, Fe, Mn, Cr, Ti, Li, Ba, Rb, and Cs). The base material can be 4-nines pure SiOC (i.e., 99.99% of the base material consists of SiOC). Embodiments of base material can have less than 0.01%, 100 ppm, (individually) of these other elements.

Unlike conventional base materials for effects pigments, embodiments of the SiOC base materials of the present effects pigments can be a gloss black, have an internal optical effect layer, be flat black, and can also be other colors across the palette of blacks to greys to whites.

In embodiments where the base material is a cured SiOC material, the base material can be clear, e.g., transparent to visible light, or it can be opaque, translucent, or have color.

The sizes of the shapes can vary, having their largest dimension, e.g., cross section, from about 0.05 μm to about 5,000 μm, larger and smaller sizes are contemplated. In embodiments the above volumetric shapes have particle sizes with a cross section of about 0.5 μm, about 1 μm, about 0.1 μm about 2 μm, about 2 μm and about 3 μm, from about 0.3 μm to about 3 μm and serve as the base for an effects layer.

In an embodiment, a platelet or flake having a flat profile is base layer. These platelets can have an average thickness of about 0.5 μm to about 2.5 μm, about 0.2 μm to about 3.5 μm, about 1.5 μm to about 2.0 μm, about 0.8 μm to about 1.2 μm, about 0.4 μm to about 0.9 μm, about 1.0 μm to about 1.3 μm microns, about 0.4 μm-1 μm, about 0.7 μm-1.5 μm, about 0.9 μm-1.2 μm, about 1.5 μm-2.5 μm, about 1 μm, and about 1 μm-2 μm, less than about 2 μm, less than about 1.5 μm and less than about 1 μm. The particle size distribution for the cross section (e.g., width or length) of the flake can range from about 2 μm to about 2,500 μm, about 25 μm to about 2,000 μm, from about 100 μm to about 1,500 μm, and can have, for example, particle size distributions of: 100-300 μm (10% or less), 300-50 μm (65% or more), and <50 μm (25% or less); 1700-150 μm (80% or more) and <150 μm (20% or less); D10≤6.00 μm, D50 11.0-14.50 μm, and D90 21.00-25.00 μm (with sieve residue 45 μm less than 2.00); D10 5.0-9.0 μm, D50 17.0-23.00 μm, and D90 35.0-45.0 μm (with sieve residue 40 μm less than 1.00%); D10 10.0-20.0 μm, D50 25.0-35.00 μm, and D90 55.0-65.0 μm. Other sizes and distributions are also contemplated.

In addition to the flake being “essentially planar” (i.e., having no more that 5% of its surface being non-planar, that is outside of a single plane) and planar, the flake can be bent, curved, have ridges, ruffles, and other surface features, topography and contours.

In addition to the flatness of the structures, the plates and flakes can have various different shapes, such as square, rectangle, triangle, trapezoidal, rhombus, stars, octagons, rods, pentagons, etc.

The surface layer, e.g., the effects layer, can have a thickness of about 1% or less of the thickness of the base, about 1% to about 5% the thickness of the base, about 2% to about 10% the thickness of the base, about 5% to about 25% the thickness of the base, about 0.1% to about 80% the thickness of the base, about 40% to about 300% the thickness of the base (for example in building a layered structure). The surface layer can have a thickness of about 2 nm (nanometers), about 4 nm, about 10 nm, about 50 nm, about 100 nm (0.1 μm), about 0.5 μm, about 1 μm, about 2 μm, from about 0.01 μm to about 10 μm, about 2 nm to about 1,000 nm, about 2 nm to about 100 nm, about 10 nm to about 500 nm, and larger and smaller thicknesses.

In addressing optical properties, generally, the thickness of the layer, or components in the layer, can affect the color of the layer. For example, 10-15 nm of thickness of a component, e.g., SiO₂, can change the color.

The SiOC base pigment is non-reactive with aqueous, solvent free, or conventional coatings. The effect coating is also preferably selected to be non-reactive with aqueous, solvent free, or conventional coatings.

In embodiments, and in particular preferred embodiments, the effect layer on a base, e.g., SiOC cured or pyrolized material creates an effect pigment.

Embodiments of the present effects pigments can have sizes falling with in the industry ranges of M: 1 to 15 μm, F: 5 to 20 μm, N: 10 to 50 μm, S: 10 to 130 μm, and L: 40 to 200 μm.

Embodiments of the present effects pigments include the application of known effects layer, using known application processes, to embodiments of the present SiOC ceramic base materials, including without limitation application to SiOC ceramic base materials having a purity of at least about 4-nines, at least about 5-nines, and between 4-nines and 6-nines. Further, in embodiments the SiOC base material is black.

Effects layers that can be applied to the SiOC base materials to form the present inventions include, without limitation, SiO₂, TiO₂, FeO₂, Fe₂O₃, Fe₃O₄, Cr₂O₂, and (Sn, Sb)O₂.

In general, in an embodiment, the effect layer can be applied to the base material by forming a solution, e.g., NaOH, salt, etc., of the coating material and mixing in the base material into that salt solution, typically with agitation and the application of heat. After a sufficient time the flakes are removed, and then subjected to a further heat treatment, e.g., calcining, typically under an inert atmosphere, e.g., N₂, Ar, from about 300° C. to about 700° C., to form the effect layer, which has sufficient hardness and durability for its intended applications. Multiple layers of the same or different effect coating can be provided in this manner. Additionally, different layers in a multi-layer effect coating can be applied using different application processes.

In a new and novel application the materials providing the effect can be built into the backbone of the SiOC material, and can be formed on the surface of the flake during pyrolysis.

The present surface effect pigments and surface effective additives can find applications and uses in many products and applications, including antistatic flooring, electrostatic painting, magnetic surface, roofing tiles, filler for improved mechanical and appearance properties of polymers

### EXAMPLES

The following examples are provided to illustrate various embodiments of systems, processes, compositions, applications and materials of the present inventions. These examples are for illustrative purposes, may be prophetic, and should not be viewed as, and do not otherwise limit the scope of the present inventions. The percentages used in the examples, unless expressly provided otherwise, are weight percents of the total, e.g., formulation, mixture, product, or structure. The usage X/Y or XY indicates % of X and the % of Y in the formulation, unless expressly provided otherwise. The usage X/Y/Z or XYZ indicates the % of X, % of Y and % of Z in the formulation, unless expressly provided otherwise.

### Example 1—Controlled Hydrophilicity/Hydrophobicity

### Example 1A

In an embodiment a surface layer of polysilocarb material is on a PDC base, for example a polysilocarb base, and can have controlled and predetermined hydrophilicity/hydrophobicity properties. The surface layer is primarily Si—Oₓ species (where x is 1-3) and is hydrophilic.

These hydrophilic surface layers can have from about 50% Si—Oₓ species in the surface layer or more, about 60% Si—Oₓ species in the surface layer or more, about 70% Si—Oₓ species in the surface layer or more, about 80% Si—Oₓ species in the surface layer or more, about 85% Si—Oₓ species in the surface layer or more, about 90% Si—Oₓ species in the surface layer or more, from about 85% to about 99% Si—Oₓ species in the surface layer, from about 65% to about 95% Si—Oₓ species in the surface layer, and about 99% Si—Oₓ species in the surface layer or more. The degree of hydrophilicity increases with increasing amounts of Si—Oₓ species in the surface layer.

### Example 1B

On the other hand, in an embodiment the surface layer is predominately Si—Cₓ (where x is from 1 to 4) and C species and is hydrophobic. These hydrophobic surface layers can have from about 50% Si—Cₓ and C species in the surface layer or more, about 60% Si—Cₓ and C species in the surface layer or more, about 70% Si—Cₓ and C species in the surface layer or more, about 80% Si—Cx and C species in the surface layer or more, about 85% Si-Cx and C species in the surface layer or more, about 90% Si—Cₓ and C species in the surface layer or more, from about 85% to about 99% Si—Cₓ and C species in the surface layer, from about 65% to about 95% Si—Cₓ and C species in the surface layer, and about 99% Si—Cₓ and C species in the surface layer or more. The degree of hydrophobicity increases with the increasing amounts of Si—Cₓ and C species in the surface layer.

### Example 1C

The controlled hydrophilicity surface effect layer flake of Examples 1A and 1B is used as a base for the addition of another effect layer.

### Example 2—Integral/Additive/Removal Effect Layers

### Example 2A

In an embodiment the surface layer, e.g., a surface layer of the Examples of the present inventions, is created by controlling pyrolysis conditions of the base, and thus would be integrally formed, i.e., an “integral effect layer.”

### Example 2B

In an embodiment the surface layer, e.g., a surface layer of the Examples of the present inventions, is created by controlling the curing conditions of the base, and thus is integrally formed, i.e., an “integral effect layer.”

### Example 2C

In an embodiment the surface layer, e.g., a surface layer of the Examples of the present inventions, is formed by removing species from the base material, i.e., a “removal effect layer.”

### Example 2D

In an embodiment the surface layer, e.g., a surface layer of the Examples of the present inventions, is added to the base, i.e., an “additive effect layer.”

### Example 2E

In an embodiment species are removed from the additive layer of the embodiments of Example 2D, i.e., an “additive-removal effect layer.”

### Example 3—Blue/Yellow Surface Effect Layer

A surface effect having blue and yellow colors or effects is provided to a ceramic SiOC substrate through an effect layer. The effect layer is integral with the SiOC substrate and has a mole ratio of Si:O:C of 1:2.14:0.55 (by weight—27% Si, 58% 0 and 15% C).

### Example 4—Green/Pink Surface Effect Layer

A surface effect having blue and yellow colors or effects is provided to a ceramic SiOC substrate through an effect layer. The effect layer is integral with the SiOC substrate and has a mole ratio of Si:O:C of 1:2.14:0.35. (by weight—28.6% Si, 61.3% 0 and 10.1% C)

### Example 5—Metallic Surface Effect

A surface effect having metallic appearance is provided to a ceramic SiOC substrate through an effect layer. The effect layer is integral with the SiOC substrate and has a mole ratio of Si:O:C of 1:1.71:29.58. It is theorized that the species on the surface are primarily siloxane, which accounts for the blue and yellow color effect.

### Example 6

A titanium dioxide effect layer is applied to a ceramic SiOC base flake. The titanium dioxide effect layer is applied by a hydrolysis technique for coating flakes. A predetermined amount of titanium sulfate is added to an aqueous suspension of amorphous ceramic SiOC flakes. The suspension is slowly heated so that the titanium salt is hydrolyzed to insoluble titanium dioxide hydrate, which will deposit on the SiOC flake as a homogenous coating. The coated flakes are then filtered off, dried and calcined at 700° C. to 900° C. in a kiln.

The process is characterized by the following equations:

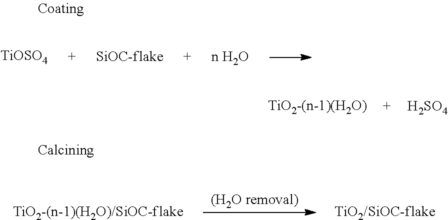

Depending upon the thickness of layer the color of the pigment can be silver, gold, red, blue and green, with increasing thickness of the coatings.

The coating layer can be about 40-60 μm, about 60-80 μm, about 80-100 μm, about 100-140 μm, about 120-160 μm,

### Example 6A

A second coating is applied to the effect layer coated flake of example 6, the second coating is a colorant.

### Example 6B

A second coating is applied to the effect layer coated flake of example 6, the second coating is an iron oxide effect layer.

### Example 7

An effects pigment having a TiO₂ effect layer coating a SiOC flake, the TiO₂ effect layer is in the rutile phase.

### Example 8

An effects pigment having a TiO₂ effect layer coating a SiOC flake, the TiO₂ effect layer is in the anatase phase.

### Example 9

A titanium dioxide effect layer is applied to a ceramic SiOC base flake. The titanium dioxide effect layer is applied by a titration technique for coating flakes. An aqueous acidic TiOCl₂ solution is continuously added to a suspension of SiOC flakes at a pH of about 2. The temperature of the suspension during addition of the TiOCl₂ is maintained at about 60° C.-90° C. The pH of the suspension is maintained at 2, by the controlled addition of NaOH. Insoluble titanium dioxide hydrate will deposit on the SiOC flake as a homogenous coating. The coated flakes are then filtered off, dried and calcined at 700° C. to 900° C. in a kiln.

The process is characterized by the following simplified equations:

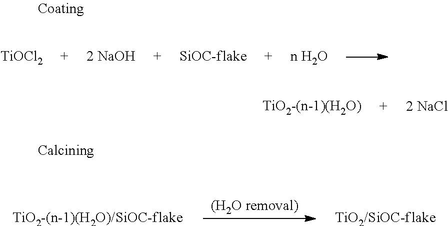

Depending upon the thickness of layer the color of the pigment can be silver, gold, red, blue and green, with increasing thickness of the coatings.

The coating layer can be about 40-60 μm, about 60-80 μm, about 80-100 μm, about 100-140 μm, about 120-160 μm,

### Example 10

A titanium dioxide rutile effect layer is applied to a SiOC flake to form an effect pigment.

An SiOC flake is coated with tin dioxide

SnCl₂+4NaOH+SiOC-flake→SnO₂/SiOC-flake+2H₂O+4NaCl

The tin oxide coated flake is then coated with TiO₂.

SnO₂/SiOC-flake+TiOCl₂+2NaOH→TiO₂/SnO₂/SiOC-flake+2NaCl+H₂O

The flake is then calicined at temperatures greater than 700° C.

TiO₂/SnO₂/SiOC-flake→TiO₂(rutile)/SnO₂/SiOC-flake

### Example 11

An iron oxide effect layer is applied to a ceramic SiOC base flake. The iron oxide effect layer is applied by known techniques of coating the flakes. A coating of metal oxide hydrates is deposited on the flakes, at a predetermined thickness, the coating is then heated, driving off the water, to provided a stable and hard coating. Depending upon the thickness of layer the color of the pigment can be bronze, copper, fire engine red, with changing thickness of the coatings.

An iron (II) or iron (III) salt solution is added drop-wise to a SiOC ceramic flake base suspension at a constant pH. The hydrated iron oxide that is thus formed on the SiOC flake is then dehydrated at temperatures between 700 C and 900 C. Generally, the following reactions describe this process.

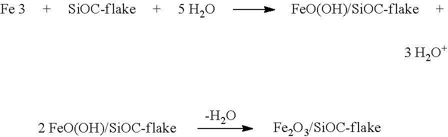

### Example 12

An SiOC flake is coated with a TiO₂ coating and then a thin layer of colorant is coated over the TiO₂ layer.

### Example 13

An SiOC flake is coated with a TiO₂ (anatase) coating and then a layer of Fe₂O₃ is coated over the TiO₂ layer.

### Example 14

An SiOC flake is coated with a TiO₂ (rutlie) coating and then a layer of Fe₂O₃ is coated over the TiO₂ layer.

### Example 15

An SiOC flake is coated with a single layer that is a mixture of TiO₂ and Fe₂O₃.

### Example 16

An SiOC flake is coated with a coating, e.g., TiO₂ coating, that contains carbon black.

### Example 17

An SiOC flake is coated with a coating of chromium oxide.

### Example 18

An SiOC flake is coated with a coating of zirconium oxide.

### Example 19

An SiOC flake is coated with a coating of silicon dioxide.

### Example 20

An SiOC flake is coated with a coating of SiOC.

### Example 21

Embodiments of SiOC flakes have multiple layers of coatings. The coatings can be the same material, the same material but different processing conditions (e.g., atmosphere, temperature), different materials and combinations and variations of these. These embodiments can have 2, 3, 4, 5 and more layers. The SiOC flakes can be the flakes of Examples 1 to 5, an SiOC flake without an intergral surface layer effect, and any of the coating of Examples 6-20.

### Example 22

SiOC flakes and palettes are made for the following formulations and conditions of Table 1. These formulations provide the ability to quickly cure the material for later pyrolysis.

TABLE 1

| | MHF-1 | MHF-1.6 | MHF-2 | MHF-3 | MHF-4 |
|---|---|---|---|---|---|
| MHF (grams) | 3.6 | 4.608 | 5.04 | 5.4 | 5.76 |
| TV (grams) | 5.16 | 4.128 | 3.642 | 2.592 | 2.094 |
| P01 (grams) | 0.0836 | 0.0989 | 0.088 | 0.0856 | 0.0843 |
| total (grams) | 8.8436 | 8.8349 | 8.77 | 8.0776 | 7.9383 |
| molar H/vi | 1.0 | 1.6 | 2.0 | 3.0 | 3.9 |
| % TV | 58.3% | 46.7% | 41.5% | 32.1% | 26.4% |
| Pt, ppm | 9.5 | 11.2 | 10.0 | 10.6 | 10.6 |
| Film forming | | | | | |
| conditions | | | | | |
| Temperature | 167 | 186 | 177 | 185 | 180 |
| cure time, | 9 | 2 | 3 | 3 | 3 |
| seconds | | | | | |
| thickness | ~2 μm | ~1 mm | ~1 mm | ~1 mm | ~1 mm |

### Example 23—Magnet Effect Additives

Magnetite is mixed into a liquid polysiloxane precursor formulation (MHF-1.6 of Example 22). This precursor formulation is cured and then the cured material is pyrolized. The pyrolized material can be in any volumetric shape, e.g., flake, disc, platelet, particle, bead, proppant. The magnetite can be added to the liquid precursor formulation from about 2% to about 60% by weight, about 5% to about 20%, about 10% to about 40% and large and smaller amounts. MHF-1.6 (of Example 22) and magnetite.

The pyrolized amorphous ceramic SiOC has the magnetite captured by the SiOC ceramic matrix. It is theorized that the magnetite is captured in the matrix, but that there are no chemical bonds formed between the magnetite and the Si—O—C in the ceramic.

The magnet effect ceramic material has inherent magnetic properties, i.e., it is a small magnet, having magnetic poles, and generating a magnetic field. In this manner, its position in a coating can be manipulated, e.g., moved, oriented, using electromagnetic fields, so that a predetermined optical affect can be provide to the coating upon curing of the coating and locking the material in place. The magnetic flakes can also be incorporated into, use in or for, active or dynamic surface devices, e.g., devices such as liquid crystal displays, and camouflage. These ceramic magnetic coatings, both active and passive, may find application in stealth technology, large displays, solar and temperature management of buildings, windows, to name a few. These ceramic magnetic coatings, can find applications across the entire electro-magnetic spectrum, including radio waves, radar, millimeter waves, microwaves, light, X-rays and gamma rays.

The magnetic amorphous ceramic material can be an additive to coatings, paints, inks, adhesives and plastics. It can also function as an effect pigment in those applications. It can also be a base material for the various coatings discussed in this specification.

### Example 24

Effect pigments having one, two, several, multiple, and combinations and variations, of the properties and features, set out in Table 2. (It being under stood that a row in the table may, but does not necessarily, define an embodiment; and thus, embodiments have properties and features combined from different rows, different columns and combinations and variations of these)

TABLE 2

| | | | | | | | | | Optical |
|---|---|---|---|---|---|---|---|---|---|
| | | | Base % | Base | | | Effect | Effect | interface |
| | Base % | Base | absorption | absorption | | Effect layer | layer - | layer - | Secondary |
| Base % | free | Thickness | of white | coefficient | Effect layer | thickness in | reflective | refractive | Reflective |
| Carbon | Carbon | μm | light | 1/cm | composition | nm | effect¹ | effect² | effect³ |
| ~5 | ~30 | ~0.1 | ~30 | ~900 | SiO₂ | ~30 | white | white | white |
| ~10 | ~40 | ~0.5 | ~35 | ~1,000 | TiO₂ | ~40 | pearl | pearl | pearl |
| ~20 | ~50 | ~1.0 | ~40 | ~1,500 | FeO₂ | ~45 | blue | blue | blue |
| ~30 | ~60 | ~1.5 | ~45 | ~1,750 | Fe₂O₃ | ~50 | Blue- | Blue- | Blue- |
| | | | | | | | green | green | green |
| ~40 | 64.86 | ~2.0 | ~50 | ~2,000 | Fe₃O₄ | ~60 | red | red | red |
| ~45 | 63.16 | ~2.5 | ~55 | ~2,250 | Cr₂O₂ | ~70 | orange | orange | orange |
| ~50 | 67.02 | ~3.0 | ~60 | ~2,500 | (Sn, Sb)O₂ | ~80 | yellow | yellow | yellow |
| ~55 | 58.59 | ~3.5 | ~65 | ~3,000 | | ~90 | violet | violet | violet |
| ~60 | 68.34 | ~4 | ~70 | ~3,500 | | ~100 | green | green | green |
| ~65 | 69.18 | ~5 | ~75 | ~4,000 | | ~110 | | | |
| ~70 | 65.66 | | ~80 | ~4,500 | | ~120 | | | |
| | ~70 | | ~90 | ~5,000 | | ~130 | | | |
| | 72.74 | | ~95 | ~5,500 | | ~140 | | | |
| | 72.46 | | ~98 | ~6,000 | | ~150 | | | |
| | 78.56 | | ~100 | ~7,000 | | ~160 | | | |
| | ~80 | | | ~7,500 | | ~170 | | | |
| | | | | ~7,750 | | ~180 | | | |
| | | | | ~8,000 | | ~190 | | | |
| | | | | ~8,250 | | | | | |
| | | | | ~8,500 | | | | | |
| | | | | ~8,750 | | | | | |
| | | | | ~9,000 | | | | | |
| | | | | ~9,250 | | | | | |
| | | | | ~9,500 | | | | | |
| | | | | ~9,750 | | | | | |
| | | | | ~10,000 | | | | | |
| | | | | ~10,500 | | | | | |
| | | | | ~11,000 | | | | | |
| | | | | ~11.500 | | | | | |
| | | | | ~12,000 | | | | | |
| | | | | ~12,500 | | | | | |
| | | | | ~13,000 | | | | | |
| | | | | ~13.500 | | | | | |
| | | | | ~14,000 | | | | | |
| | | | | ~14,500 | | | | | |
| | | | | ~15,000 | | | | | |
| | | | | ~15,500 | | | | | |
| | | | | ~16,000 | | | | | |
| | | | | ~16,500 | | | | | |
| | | | | ~17,000 | | | | | |
| | | | | ~18,000 | | | | | |
| | | | | ~19,000 | | | | | |

¹Effect Layer - Reflective Effect means the visual appearance (e.g., wavelength) of light that is reflected from the layer when white light is directed onto the layer. Thus, white would be 380-750 nm, pearl is essentially a white or beige, with some wavelengths of white absent, Indigo or violet ~400 (380-450 nm), blue ~475 (450-495 nm), green ~510 (495-570 nm), yellow ~580 (570-590 nm), orange ~600 (590-620 nm), red ~650 (620-750 nm).
²Effect Layer - Refractive Effect means the visual appearance (e.g., wavelength) of light that is transmitted through the layer when white light is directed onto the layer. Thus, white would be 380-750 nm, pearl is essentially a white or beige, with some wavelengths of white absent, Indigo or violet ~400 (380-450 nm), blue ~475 (450-495 nm, green ~510 (495-570 nm), yellow ~580 (570-590 nm), orange ~600 (590-620 nm), red ~650 (620-750 nm).
³Optical interface - Secondary Reflective Effect means the visual appearance (e.g., wavelength) of light that is reflected at optical interface between the layer and the base when refractive light is directed onto the base, after passing through the layer. Thus, white would be 380-750 nm, pearl is essentially a white or beige, with some wavelengths of white absent, Indigo or violet ~400 (380-450 nm), blue ~475 (450-495 nm), green ~510 (495-570 nm), yellow ~580 (570-590 nm), orange ~600 (590-620 nm), red ~650 (620-750 nm).

It being understood that these effect pigments will typically have more optical and other optical effects, in addition to those identified in Table 2. For example, the effects, materials and structures in Table 2, will typically product additional, or tertiary effects, such as a complex pattern of rays (including various polarizations and wavelengths, as well as interference, amplification and cancellation). This complex ray pattern gives a coating or material containing these effect pigments, the unique brilliance, pop, shimmer, etc., that make these effect pigments in certain applications highly desirable.

As the amount of carbon, and the amount of free carbon is beleved to effect several of the optical props

### Overview—Polysilocarb Formulations, Methods & Materials

Formulations, processes, methods of making, and compositions for various polysilocarbs are taught and disclosed in U.S. Pat. Nos. 9,499,677, 9,481,781 and US Patent Publication Nos. 2014/0274658, 2014/0323364, 2015/0175750, 2016/0207782, 2016/0280607, 2017/0050337, the entire disclosure of each of which are incorporated herein by reference.

### General Processes for Obtaining a Polysilocarb Precursor

Typically, polymer derived ceramic precursor formulations, and in particular, polysilocarb precursor formulations, can generally be made by three types of processes, although other processes, and variations and combinations of these processes may be utilized. These processes generally involve combining precursors to form a precursor formulation. One type of process generally involves the mixing together of precursor materials in preferably a solvent free process with essentially no chemical reactions taking place, e.g., “the mixing process.” The other type of process generally involves chemical reactions, e.g., “the reaction type process,” to form specific, e.g., custom, precursor formulations, which could be monomers, dimers, trimers and polymers. A third type of process has a chemical reaction of two or more components in a solvent free environment, e.g., “the reaction blending type process.” Generally, in the mixing process essentially all, and preferably all, of the chemical reactions take place during subsequent processing, such as during curing, pyrolysis and both.

It should be understood that these terms—reaction type process, reaction blending type process, and the mixing type process—are used for convenience and as a short hand reference. These terms, i.e., process types, are not, and should not be viewed as, limiting. For example, the reaction type process can be used to create a precursor material that is then used in the mixing type process with another precursor material.

These process types are described in this specification, among other places, under their respective headings. It should be understood that the teachings for one process, under one heading, and the teachings for the other processes, under the other headings, can be applicable to each other, as well as, being applicable to other sections, embodiments and teachings in this specification, and vice versa. The starting or precursor materials for one type of process may be used in the other type of processes. Further, it should be understood that the processes described under these headings should be read in context with the entirely of this specification, including the various examples and embodiments.

It should be understood that combinations and variations of these processes may be used in reaching a precursor formulation, and in reaching intermediate, end, and final products. Depending upon the specific process and desired features of the product, the precursors and starting materials for one process type can be used in the other. A formulation from the mixing type process may be used as a precursor, or component in the reaction type process, or the reaction blending type process. Similarly, a formulation from the reaction type process may be used in the mixing type process and the reaction blending process. Similarly, a formulation from the reaction blending type process may be used in the mixing type process and the reaction type process. Thus, and preferably, the optimum performance and features from the other processes can be combined and utilized to provide a cost effective and efficient process and end product. These processes provide great flexibility to create custom features for intermediate, end, and final products, and thus, any of these processes, and combinations of them, can provide a specific predetermined product. In selecting which type of process is preferable, factors such as cost, controllability, shelf life, scale up, manufacturing ease, etc., can be considered.

The precursor formulations may be used to form a “neat” material (by “neat” material it is meant that all, and essentially all of the structure is made from the precursor material or unfilled formulation; and thus, for example, there are no fillers or reinforcements). The precursor formulations may be used to form a filled material, e.g., having an additive or other material in addition to the precursors. They may be used to form composite materials, e.g., structures or coatings having other materials such as reinforcements in them. They may be used to form non-reinforced materials, which are materials that are made of primarily, essentially, and preferably only from the precursor materials, e.g., minimally filled materials where the filler is not intended to add or enhance strength, and unfilled materials. They may be sued to form reinforced materials, for example materials having fibers or other materials to add strength, abrasion resistance, durability, or other features or properties, that generally are viewed as strength related in a broad sense.

In general, types of filler material include, for example: inert fillers, such as inorganic materials that do not react with the SiOC matrix during curing, pyrolysis or use; reactive fillers, such as zirconium, aluminum hydroxide, and boron compounds that react with the SiOC matrix during curing, pyrolysis, use, or combinations of these; and, active fillers, such as materials that are released during the use of the end product to provide specific features to that product, e.g., lubricant. A filler may come under more than one of these types.

The filler material may also be made from, or derived from the same material as the formulation that has been formed into a cured or pyrolized solid, or it may be made from a different precursor formulation material, which has been formed into a cured solid or semi-solid, or pyrolized solid.

The polysilocarb formulation and products derived or made from that formulation may have metals and metal complexes. Thus, metals as oxides, carbides or silicides can be introduced into precursor formulations, and thus into a silica matrix in a controlled fashion. For example, organometallic, metal halide (chloride, bromide, iodide), metal alkoxide and metal amide compounds of transition metals can be copolymerized in the silica matrix, through incorporation into a precursor formulation.

The filler material can impart, regulate or enhance, features and properties, for example, electrical resistance, magnetic capabilities, band gap features, p-n junction features, p-type features, n-type features, dopants, electrical conductivity, semiconductor features, anti-static, optical properties (e.g., reflectivity, refractivity and iridescence), chemical resistivity, corrosion resistance, wear resistance, abrasions resistance, thermal insulation, UV stability, UV protective, and other features or properties that may be desirable, necessary, and both, in the end product or material.

Thus, filler materials could include copper lead wires, thermal conductive fillers, electrically conductive fillers, lead, optical fibers, ceramic colorants, pigments, oxides, dyes, powders, ceramic fines, polymer derived ceramic particles, pore-formers, carbosilanes, silanes, silazanes, silicon carbide, carbosilazanes, siloxane, metal powders, ceramic powders, metals, metal complexes, carbon, tow, fibers, staple fibers, boron containing materials, milled fibers, glass, glass fiber, fiber glass, and nanostructures (including nanostructures of the forgoing) to name a few. For example, crushed, polymer derived ceramic particles, e.g., fines or beads, can be added to a polysilocarb formulation and then cured to form a filled cured plastic material, which has significant fire resistant properties as a coating or in a device or component of a device.

The polysilocarb precursor formulations may be used with reinforcing materials to form composite layers or coatings. Thus, for example, the formulation may be flowed into, impregnated into, absorbed by or otherwise combined with a thin reinforcing material, such as carbon fibers, glass fiber, woven fabric, non-woven fabric, copped fibers, fibers, rope, braided structures, ceramic powders, glass powders, carbon powders, graphite powders, ceramic fibers, metal powders, carbide pellets or components, staple fibers, tow, nanostructures of the above, PDCs, any other material that meets the temperature requirements of the process and end product, and combinations and variations of these. Thus, for example, the reinforcing materials may be any of the high temperature resistant reinforcing materials currently used, or capable of being used with, existing plastics and ceramic composite materials. Additionally, because the polysilocarb precursor formulation may be formulated for a lower temperature cure (e.g., SATP) or a cure temperature of for example about 37.8° C. (100° F.) to about 204.4° C. (400° F.), the reinforcing material may be polymers, organic polymers, such as nylons, polypropylene, and polyethylene, as well as aramid fibers, such as NOMEX or KEVLAR.

The reinforcing material may also be made from, or derived from the same material as the formulation that has been formed into a fiber, cured into a solid, pyrolized into a ceramic, or it may be made from a different precursor formulation material, which has been formed into a fiber, pyrolized into a ceramic and combinations and variations of these. In addition to ceramic fibers derived from the precursor formulation materials that may be used as reinforcing material, other porous, substantially porous, and non-porous ceramic structures derived from a precursor formulation material may be used.

The polysilocarb material (e.g., precursor batch, precursor, formulation, bulk liquid, etc.), can have various inhibitors, catalysts and initiator present that inhibit, regulate, or promote curing, under predetermined conditions. Thus, the polysilocarb coating material can have sufficient inhibitors present, or the absence of a catalyst, to provide the required shelf life for the material in storage.

The Mixing Type Process

Precursor materials may be a methyl hydrogen (methyl terminated hydride substituted polysiloxane), methyl hydrogen fluid (methyl terminated hydride methyl substitute polysiloxane, with little to no dimethyl groups) and substituted and modified methyl hydrogens, siloxane backbone materials, siloxane backbone additives, reactive monomers, reaction products of a siloxane backbone additive with a silane modifier or an organic modifier, and other similar types of materials, such as silane based materials, silazane based materials, carbosilane based materials, non-silicon based organic cross linkers, phenol/formaldehyde based materials, and combinations and variations of these. The precursors are preferably liquids at room temperature, although they may be solids that are melted, or that are soluble in one of the other precursors. (In this situation, however, it should be understood that when one precursor dissolves another, it is nevertheless not considered to be a “solvent” as that term is used with respect to the prior art processes that employ non-constituent solvents, e.g., solvents that do not form a part or component of the end product, are treated as waste products, and both.)

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation” or a “formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or over a time period, prior to being cured.

The precursors can be mixed under numerous types of atmospheres and conditions, e.g., air, inert, N₂, Argon, flowing gas, static gas, reduced pressure, elevated pressure, ambient pressure, and combinations and variations of these.

Additionally, inhibitors such as cyclohexane, 1-Ethynyl-1-cyclohexanol (which may be obtained from ALDRICH), Octamethylcyclotetrasiloxane (which may be viewed as a dilutant), and tetramethyltetravinylcyclotetrasiloxane, may be added to the polysilocarb precursor formulation, e.g., to form an inhibited polysilocarb precursor formulation. It should be noted that tetramethyltetravinylcyclotetrasiloxane may act as both a reactant and a reaction retardant (e.g., an inhibitor), depending upon the amount present and temperature, e.g., at room temperature it is a retardant and at elevated temperatures it is a reactant. Other materials, as well, may be added to the polysilocarb precursor formulation, e.g., a filled polysilocarb precursor formulation, at this point in processing, including fillers such as SiC powder, carbon black, sand, polymer derived ceramic particles, pigments, particles, nano-tubes, whiskers, or other materials, discussed in this specification or otherwise known to the arts. Further, a formulation with both inhibitors and fillers would be considered an inhibited, filled polysilocarb precursor formulation.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a cured material or structure.

The catalyst can be any platinum (Pt) based catalyst, which can, for example, be diluted to ranges of: about 0.01 parts per million (ppm) Pt to about 250 ppm Pt, about 0.03 ppm Pt, about 0.1 ppm Pt, about 0.2 ppm Pt, about 0.5 ppm Pt, about 0.02 to 0.5 ppm Pt, about 1 ppm to 200 ppm Pt and preferably, for some applications and embodiments, about 5 ppm to 50 ppm Pt. The catalyst can be a peroxide based catalyst with, for example, a 10 hour half life above 90 C at a concentration of between 0.1% to 3% peroxide, and about 0.5% and 2% peroxide. It can be an organic based peroxide. It can be any organometallic catalyst capable of reacting with Si—H bonds, Si—OH bonds, or unsaturated carbon bonds, these catalysts may include: dibutyltin dilaurate, zinc octoate, peroxides, organometallic compounds of for example titanium, zirconium, rhodium, iridium, palladium, cobalt or nickel. Catalysts may also be any other rhodium, rhenium, iridium, palladium, nickel, and ruthenium type or based catalysts. Combinations and variations of these and other catalysts may be used. Catalysts may be obtained from ARKEMA under the trade name LUPEROX, e.g., LUPEROX 231; and from Johnson Matthey under the trade names: Karstedt's catalyst, Ashby's catalyst, Speier's catalyst. Transition metal catalysis, such as Fe catalysis, Ni catalysis, and Co catalysis, that for example are used in the growth of ordered and highly ordered carbon structures, such as carbon nanotubes, can also be used.

Further, custom and specific combinations of these and other catalysts may be used, such that they are matched to specific formulations, and in this way selectively and specifically catalyze the reaction of specific constituents. Moreover, the use of these types of matched catalyst-formulations systems, as well as, process conditions, may be used to provide predetermined product features, such as for example, pore structures, porosity, densities, density profiles, high purity, ultra high purity, and other morphologies or features of cured structures or materials, and in some instances the ceramics that are formed from the cured structures or materials.

In this mixing type process for making a precursor formulation, preferably chemical reactions or molecular rearrangements only take place during the making of the raw starting materials, the curing process, and in the pyrolizing process. Preferably, in the embodiments of these mixing type of formulations and processes, polymerization, crosslinking or other chemical reactions take place primarily, preferably essentially, and more preferably solely during the curing process.

The precursor may be a methyl terminated hydride substituted polysiloxane, which can be referred to herein as methyl hydrogen (MH), having the formula shown below.

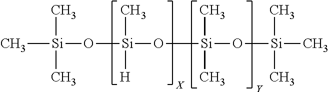

The MH, for example, may have a molecular weight (“mw” which can be measured as weight averaged molecular weight in amu or as g/mol) from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. This precursor may also, among other things, be modified by reacting with unsaturated carbon compounds to produce new, or additional, precursors. Typically, methyl hydrogen fluid (MHF) has minimal amounts of “Y”, and more preferably “Y” is for all practical purposes zero.

The precursor may be any of the following linear siloxane backbone materials.

The precursor may be a vinyl substituted polydimethyl siloxane, which formula is shown below.

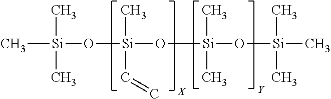

This precursor, for example, may have a molecular weight (mw) from about 400 mw to about 10,000 mw, and may have a viscosity preferably from about 50 cps to about 2,000 cps. The percentage of methylvinylsiloxane units “X” may be from 1% to 100%. The percentage of the dimethylsiloxane units “Y” may be from 0% to 99%. Preferably, X is about 100%. This precursor may be used to increase cross-link density and improve toughness, as well as, other features and characteristics to the cured preform and ceramic material.

The precursor may be a vinyl substituted and vinyl terminated polydimethyl siloxane, which formula is shown below.

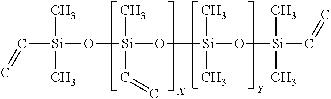

This precursor, for example, may have a molecular weight (mw) from about 500 mw to about 15,000 mw, and may preferably have a molecular weight from about 500 mw to 1,000 mw, and may have a viscosity preferably from about 10 cps to about 200 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be a vinyl substituted and hydrogen terminated polydimethyl siloxane, which formula is shown below.

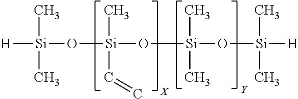

This precursor may have a molecular weight (mw) from about 300 mw to about 10,000 mw, and may preferably have a molecular weight from about 400 mw to 800 mw, and may have a viscosity preferably from about 20 cps to about 300 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be an allyl terminated polydimethyl siloxane, which formula is shown below.

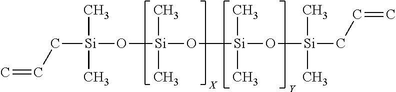

This precursor may have a molecular weight (mw) from about 400 mw to about 10,000 mw, and may have a viscosity preferably from about 40 cps to about 400 cps. The repeating units are the same. This precursor may be used to provide UV curability and to extend the polymeric chain, as well as, other features and characteristics to the cured preform and ceramic material.

The precursor may be a vinyl terminated polydimethyl siloxane

(VT), which formula is shown below.

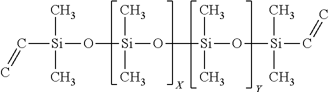

This precursor may have a molecular weight (mw) from about 200 mw to about 5,000 mw, and may preferably have a molecular weight from about 400 mw to 1,500 mw, and may have a viscosity preferably from about 10 cps to about 400 cps. The repeating units are the same. This precursor may be used to provide a polymeric chain extender, improve toughness and to lower cure temperature down to for example room temperature curing, as well as, other features and characteristics to the cured preform and ceramic material.

The precursor may be a silanol (hydroxy) terminated polydimethyl siloxane, which formula is shown below.

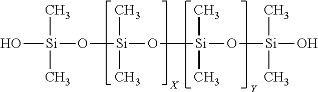

This precursor may have a molecular weight (mw) from about 400 mw to about 10,000 mw, and may preferably have a molecular weight from about 600 mw to 1,000 mw, and may have a viscosity preferably from about 30 cps to about 400 cps. The repeating units are the same. This precursor may be used to provide a polymeric chain extender, a toughening mechanism, can generate nano- and micro-scale porosity, and allows curing at room temperature, as well as other features and characteristics to the cured preform and ceramic material.

The precursor may be a silanol (hydroxy) terminated vinyl substituted dimethyl siloxane, which formula is shown below.

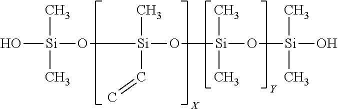

This precursor may have a molecular weight (mw) from about 400 mw to about 10,000 mw, and may preferably have a molecular weight from about 600 mw to 1,000 mw, and may have a viscosity preferably from about 30 cps to about 400 cps. The percentage of methylvinylsiloxane units “X” may be from 1% to 100%. The percentage of the dimethylsiloxane units “Y” may be from 0% to 99%. This precursor may be used, among other things, in a dual-cure system; in this manner the dual-cure can allow the use of multiple cure mechanisms in a single formulation. For example, both condensation type cure and addition type cure can be utilized. This, in turn, provides the ability to have complex cure profiles, which for example may provide for an initial cure via one type of curing and a final cure via a separate type of curing.

The precursor may be a hydrogen (hydride) terminated polydimethyl siloxane, which formula is shown below.

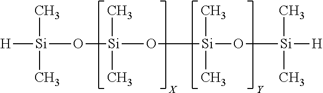

This precursor may have a molecular weight (mw) from about 200 mw to about 10,000 mw, and may preferably have a molecular weight from about 500 mw to 1,500 mw, and may have a viscosity preferably from about 20 cps to about 400 cps. The repeating units are the same. This precursor may be used to provide a polymeric chain extender, as a toughening agent, and it allows lower temperature curing, e.g., room temperature, as well as, other features and characteristics to the cured preform and ceramic material.

The precursor may be a di-phenyl terminated siloxane (which may also be referred to as phenyl terminated), which formula is shown below.

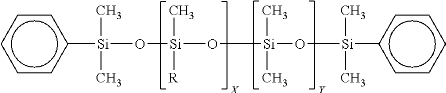

Where here R is a reactive group, such as vinyl, hydroxy, or hydride. This precursor may have a molecular weight (mw) from about 500 mw to about 2,000 mw, and may have a viscosity preferably from about 80 cps to about 300 cps. The percentage of methyl-R-siloxane units “X” may be from 1% to 100%. The percentage of the dimethylsiloxane units “Y” may be from 0% to 99%. This precursor may be used to provide a toughening agent, and to adjust the refractive index of the polymer to match the refractive index of various types of glass, to provide for example transparent fiberglass, as well as, other features and characteristics to the cured preform and ceramic material.

The precursor may be a mono-phenyl terminated siloxane (which may also be referred to as trimethyl terminated, phenyl terminated siloxane), which formulas are shown below.

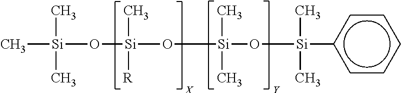

Where R is a reactive group, such as vinyl, hydroxy, or hydride. This precursor may have a molecular weight (mw) from about 500 mw to about 2,000 mw, and may have a viscosity preferably from about 80 cps to about 300 cps. The percentage of methyl-R-siloxane units “X” may be from 1% to 100%. The percentage of the dimethylsiloxane units “Y” may be from 0% to 99%. This precursor may be used to provide a toughening agent and to adjust the refractive index of the polymer to match the refractive index of various types of glass, to provide for example transparent fiberglass, as well as, other features and characteristics to the cured preform and ceramic material.

The precursor may be a diphenyl dimethyl polysiloxane, which formula is shown below.

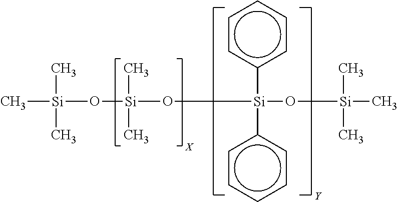

This precursor may have a molecular weight (mw) from about 500 mw to about 20,000 mw, and may have a molecular weight from about 800 to about 4,000, and may have a viscosity preferably from about 100 cps to about 800 cps. The percentage of dimethylsiloxane units “X” may be from 25% to 95%. The percentage of the diphenyl siloxane units “Y” may be from 5% to 75%. This precursor may be used to provide similar characteristics to the mono-phenyl terminated siloxane, as well as, other features and characteristics to the cured preform and ceramic material.

The precursor may be a vinyl terminated diphenyl dimethyl polysiloxane, which formula is shown below.

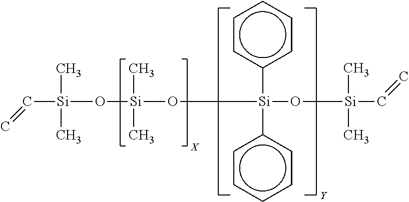

This precursor may have a molecular weight (mw) from about 400 mw to about 20,000 mw, and may have a molecular weight from about 800 to about 2,000, and may have a viscosity preferably from about 80 cps to about 600 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, as well as, other features and characteristics to the cured preform and ceramic material.

The precursor may be a hydroxy terminated diphenyl dimethyl polysiloxane, which formula is shown below.

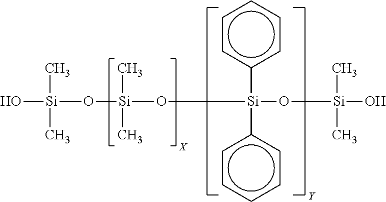

This precursor may have a molecular weight (mw) from about 400 mw to about 20,000 mw, and may have a molecular weight from about 800 to about 2,000, and may have a viscosity preferably from about 80 cps to about 400 cps. The percentage of dimethylsiloxane units “X” may be from 25% to 95%. The percentage of the diphenyl siloxane units “Y” may be from 5% to 75%. This precursor may be used to provide chain extension, toughening agent, changed or altered refractive index, and improvements to high temperature thermal stability of the cured material, can generate nano- and micro-scale porosity, as well as other features and characteristics to the cured preform and ceramic material.

This precursor may be a methyl terminated phenylethyl polysiloxane, (which may also be referred to as styrene vinyl benzene dimethyl polysiloxane), which formula is shown below.

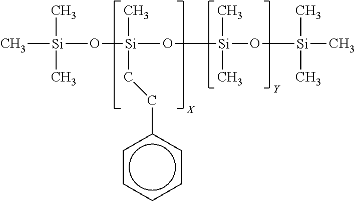

This precursor may have a molecular weight (mw) may be from about 800 mw to at least about 10,000 mw to at least about 20,000 mw, and may have a viscosity preferably from about 50 cps to about 350 cps. The percentage of styrene vinyl benzene siloxane units “X” may be from 1% to 60%. The percentage of the dimethylsiloxane units “Y” may be from 40% to 99%. This precursor may be used to provide improved toughness, decreases reaction cure exotherm, may change or alter the refractive index, adjust the refractive index of the polymer to match the refractive index of various types of glass, to provide for example transparent fiberglass, as well as, other features and characteristics to the cured preform and ceramic material.

The forgoing linear siloxane backbone materials, are by way of example, and it is understood that other similar linear siloxane backbone materials can also be used as precursors. More complex linear and branched siloxane backbone materials may be used as precursors, but are not preferred.

A variety of cyclosiloxanes can be used as precursors, and are reactive molecules, in the formulation. They can be described by the following nomenclature system or formula: DₓD*_{y}, where “D” represents a dimethyl siloxy unit and “D*” represents a substituted methyl siloxy unit, where the “*” group could be vinyl, allyl, hydride, hydroxy, phenyl, styryl, alkyl, cyclopentadienyl, or other organic group, x is from 0-8, y is >=1, and x+y is from 3-8. Further, in this nomenclature system—D represents —SiO₂ groups, typically Me₂SiO₂, Q represents SiO₄, T represents —SiO₃ groups, typically MeSiO₃ and M represent —SiO groups, typically Me₃SiO.

The precursor batch may also: (i) contain non-silicon based precursors, such as non-silicon based cross-linking agents; (ii) be the reaction product of a non-silicon based cross linking agent and a silicon based precursor; and, (iii) combinations and variation of these. The non-silicon based cross-linking agents are intended to, and provide, the capability to cross-link during curing. For example, non-silicon based cross-linking agents include: cyclopentadiene (CP), methylcyclopentadiene (MeCP), dicyclopentadiene (DCPD), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, or other Si bond in a precursor, can be used as a cross-linking agent. Some organic materials containing oxygen, nitrogen, and sulphur may also function as cross-linking agents.

The amount of the non-silicon based cross-linking agent to the silicon based precursor can be from about 10% to 90% non-silicon based cross-linker to 10% to 90% silicon based precursor (preferably a silicon backbone, e.g., —Si—O— backbone, material). Thus, the ranges of amounts can be, for example: DCPD/MHF from 10/90 to 90/10, about 40/60 to 60/40, about 50/50, and combinations and variations of these ratios, as well as other ratios. A third and fourth precursor material may also be used. Thus, the ratio of non-silicon cross linker/silicon backbone precursor/third precursor, can be: form about 10% to about 80% non-silicon based cross linker; from about 10% to 80% silicon based precursor: and form about 0.1% to 40% third precursor. The ranges and amounts can be, for example: DCPD/MHF/3^{rd} precursor from about 10/20/70 to 70/20/10, from about 10/20/70 to 10/70/20, from about 45/55/10 to about 55/45/10, from about 40/55/5 to about 55/40/5 and combinations and variations of these ratios as well as other ratios.

The precursor may be a reactive monomer. These would include molecules, such as tetramethyltetravinylcyclotetrasiloxane (TV), which formula is shown below.

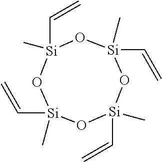 [SMILES: C=C[Si]1(C)O[Si](C)(C=C)O[Si](C)(C=C)O[Si](C)(C=C)O1]

This precursor may be used to provide a branching agent, a three-dimensional cross-linking agent, as well as, other features and characteristics to the cured preform and ceramic material. (It is also noted that in certain formulations, e.g., above 2%, and certain temperatures, e.g., about from about room temperature to about 60° C., this precursor may act as an inhibitor to cross-linking, e.g., in may inhibit the cross-linking of hydride and vinyl groups.)

The precursor may be a reactive monomer, for example, such as trivinyl cyclotetrasiloxane,

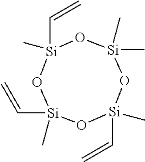 [SMILES: C=C[Si]1(C)O[Si](C)(C)O[Si](C)(C=C)O[Si](C)(C=C)O1]

divinyl cyclotetrasiloxane,

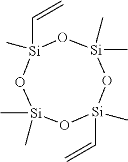

trivinyl monohydride cyclotetrasiloxane,

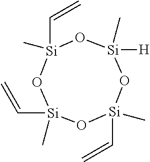 [SMILES: C=C[Si]1(C)O[SiH](C)O[Si](C)(C=C)O[Si](C)(C=C)O1]

divinyl dihydride cyclotetrasiloxane,

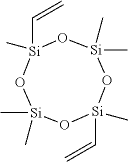

and a hexamethyl cyclotetrasiloxane, such as,

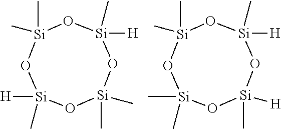

The precursor may be a silane modifier, such as vinyl phenyl methylsilane, diphenylsilane, diphenylmethylsilane, and phenylmethylsilane (some of which may be used as an end capper or end termination group). These silane modifiers can provide chain extenders and branching agents. They also improve toughness, alter refractive index, and improve high temperature cure stability of the cured material, as well as improving the strength of the cured material, among other things. A precursor, such as diphenylmethylsilane, may function as an end capping agent, that may also improve toughness, alter refractive index, and improve high temperature cure stability of the cured material, as well as, improving the strength of the cured material, among other things.

The precursor may be a reaction product of a silane modifier with a vinyl terminated siloxane backbone additive. The precursor may be a reaction product of a silane modifier with a hydroxy terminated siloxane backbone additive. The precursor may be a reaction product of a silane modifier with a hydride terminated siloxane backbone additive. The precursor may be a reaction product of a silane modifier with TV. The precursor may be a reaction product of a silane. The precursor may be a reaction product of a silane modifier with a cyclosiloxane, taking into consideration steric hindrances. The precursor may be a partially hydrolyzed tertraethyl orthosilicate, such as TES 40 or Silbond 40. The precursor may also be a methylsesquisiloxane such as SR-350 available from Momentive (previously from General Electric Company, Wilton, Conn.). The precursor may also be a phenyl methyl siloxane such as 604 from Wacker Chemie AG. The precursor may also be a methylphenylvinylsiloxane, such as H62 C from Wacker Chemie AG.

The precursors may also be selected from the following: SiSiB® HF2020, TRIMETHYLSILYL TERMINATED METHYL HYDROGEN SILICONE FLUID 63148-57-2; SiSiB® HF2050 TRIMETHYLSILYL TERMINATED METHYLHYDROSILOXANE DIMETHYLSILOXANE COPOLYMER 68037-59-2; SiSiB® HF2060 HYDRIDE TERMINATED METHYLHYDROSILOXANE DIMETHYLSILOXANE COPOLYMER 69013-23-6; SiSiB® HF2038 HYDROGEN TERMINATED POLYDIPHENYL SILOXANE; SiSiB® HF2068 HYDRIDE TERMINATED METHYLHYDROSILOXANE DIMETHYLSILOXANE COPOLYMER 115487-49-5; SiSiB® HF2078 HYDRIDE TERMINATED POLY(PHENYLDIMETHYLSILOXY) SILOXANE PHENYL SILSESQUIOXANE, HYDROGEN-TERMINATED 68952-30-7; SiSiB® VF6060 VINYLDIMETHYL TERMINATED VINYLMETHYL DIMETHYL POLYSILOXANE COPOLYMERS 68083-18-1; SiSiB® VF6862 VINYLDIMETHYL TERMINATED DIMETHYL DIPHENYL POLYSILOXANE COPOLYMER 68951-96-2; SiSiB® VF6872 VINYLDIMETHYL TERMINATED DIMETHYL-METHYLVINYL-DIPHENYL POLYSILOXANE COPOLYMER; SiSiB® PC9401 1,1,3,3-TETRAMETHYL-1,3-DIVINYLDISILOXANE 2627-95-4; SiSiB® PF1070 SILANOL TERMINATED POLYDIMETHYLSILOXANE (OF1070) 70131-67-8; SiSiB® OF1070 SILANOL TERMINATED POLYDIMETHYSILOXANE 70131-67-8; OH-ENDCAPPED POLYDIMETHYLSILOXANE HYDROXY TERMINATED OLYDIMETHYLSILOXANE 73138-87-1; SiSiB® VF6030 VINYL TERMINATED POLYDIMETHYL SILOXANE 68083-19-2; and, SiSiB® HF2030 HYDROGEN TERMINATED POLYDIMETHYLSILOXANE FLUID 70900-21-9.

Thus, in additional to the forgoing type of precursors, it is contemplated that a precursor may be a compound of the following general formula.

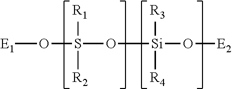

Wherein end cappers E₁ and E₂ are chosen from groups such as trimethylsiliy (trimethyl silicon) (—Si(CH₃)₃), dimethylsilyl hydroxy (dimethyl silicon hydroxy) (—Si(CH₃)₂OH), dimethylhydridosilyl (dimethyl silicon hydride) (—Si(CH₃)₂H), dimethylvinylsilyl (dimethyl vinyl silicon) (—Si(CH₃)₂(CH═CH₂)), dimethylphenylsily (—Si(CH₃)₂(C₆H₅)) and dimethylalkoxysilyl (dimethyl alkoxy silicon) (—Si(CH₃)₂(OR). The R groups R₁, R₂, R₃, and R₄ may all be different, or one or more may be the same. Thus, for example, R₂ is the same as R₃, R₃ is the same as R₄, R₁ and R₂ are different with R₃ and R₄ being the same, etc. The R groups are chosen from groups such as hydride (—H), methyl (Me)(—C), ethyl (—C—C), vinyl (—C═C), alkyl (—R)(CₙH₂ₙ₊₁), allyl (—C—C═C), aryl (′R), phenyl (Ph)(—C₆H₅), methoxy (—O—C), ethoxy (—O—C—C), siloxy (—O—Si—R₃), alkoxy (—O—R), hydroxy (—O—H), phenylethyl (—C—C—C₆H₅) and methyl,phenyl-ethyl (—C—C(—C)(—C₆H₅).

In general, embodiments of formulations for polysilocarb formulations may, for example, have from about 0% to 50% MHF, about 20% to about 99% MHF, about 0% to about 30% siloxane backbone material, about 20% to about 99% siloxane backbone materials, about 0% to about 70% reactive monomers, about 0% to about 95% TV, about 0% to about 70% non-silicon based cross linker, and, about 0% to about 90% reaction products of a siloxane backbone additives with a silane modifier or an organic modifier reaction product.

In mixing the formulations sufficient time should be used to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should preferably be kept below about 45° C., and preferably about 10° C. (It is noted that these mixing conditions are for the pre-catalyzed formulations.)

The Reaction Type Process

In the reaction type process, in general, a chemical reaction is used to combine one, two or more precursors, typically in the presence of a solvent, to form a precursor formulation that is essentially made up of a single polymer that can then be, catalyzed, cured and pyrolized. This process provides the ability to build custom precursor formulations that when cured can provide plastics having unique and desirable features. The cured materials can also be pyrolized to form ceramics having unique features. The reaction type process allows for the predetermined balancing of different types of functionality in the end product by selecting functional groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

In general a custom polymer for use as a precursor formulation is made by reacting precursors in a condensation reaction to form the polymer precursor formulation. This precursor formulation is then cured into a preform, i.e., plastic, cured solid or semi-solid material, through a hydrolysis reaction. The condensation reaction forms a polymer of the type shown below.

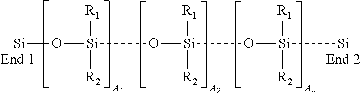

Where R₁ and R₂ in the polymeric units can be a hydride (—H), a methyl (Me)(—C), an ethyl (—C—C), a vinyl (—C═C), an alkyl (—R)(CₙH₂ₙ₊₁), an unsaturated alkyl (—CₙH₂ₙ₋₁), a cyclic alkyl (—CₙH₂ₙ₋₁), an allyl (—C—C═C), a butenyl (—C₄H₇), a pentenyl (—C₅H₉), a cyclopentenyl (—C₅H₇), a methyl cyclopentenyl (—O₅H₆(CH₃)), a norbornenyl (—C_{X}H_{Y}, where X=7-15 and Y=9-18), an aryl (′ R), a phenyl (Ph)(—C₆H₅), a cycloheptenyl (—C₇H₁₁), a cyclooctenyl (—C₈H₁₃), an ethoxy (—O—C—C), a siloxy (—O—Si—R₃), a methoxy (—O—C), an alkoxy, (—O—R), a hydroxy, (—O—H), a phenylethyl (—C—C—C₆H₅) a methyl,phenyl-ethyl (—C—C(—C)(—C₆H₅)) and a vinylphenyl-ethyl (—C—C(C₆H₄(—C═C))). R₁ and R₂ may be the same or different. The custom precursor polymers can have several different polymeric units, e.g., A₁, A₂, Aₙ, and may include as many as 10, 20 or more units, or it may contain only a single unit, for example, MHF made by the reaction process may have only a single unit.

Embodiments may include precursors, which include among others, a triethoxy methyl silane, a diethoxy methyl phenyl silane, a diethoxy methyl hydride silane, a diethoxy methyl vinyl silane, a dimethyl ethoxy vinyl silane, a diethoxy dimethyl silane. an ethoxy dimethyl phenyl silane, a diethoxy dihydride silane, a triethoxy phenyl silane, a diethoxy hydride trimethyl siloxane, a diethoxy methyl trimethyl siloxane, a trimethyl ethoxy silane, a diphenyl diethoxy silane, a dimethyl ethoxy hydride siloxane, and combinations and variations of these and other precursors, including other precursors set forth in this specification.

The end units, Si End 1 and Si End 2, can come from the precursors of dimethyl ethoxy vinyl silane, ethoxy dimethyl phenyl silane, and trimethyl ethoxy silane. Additionally, if the polymerization process is properly controlled a hydroxy end cap can be obtained from the precursors used to provide the repeating units of the polymer.

In general, the precursors are added to a vessel with ethanol (or other material to absorb heat, e.g., to provide thermal mass), an excess of water, and hydrochloric acid (or other proton source). This mixture is heated until it reaches its activation energy, after which the reaction typically is exothermic. Generally, in this reaction the water reacts with an ethoxy group of the silane of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Control factors for determining chain length, among others, are: the monomers chosen (generally, the smaller the monomers the more that can be added before they begin to coil around and bond to themselves); the amount and point in the reaction where end cappers are introduced; and the amount of water and the rate of addition, among others. Thus, the chain lengths can be from about 180 mw (viscosity about 5 cps) to about 65,000 mw (viscosity of about 10,000 cps), greater than about 1000 mw, greater than about 10,000 mw, greater than about 50,000 mw and greater. Further, the polymerized precursor formulation may, and typically does, have polymers of different molecular weights, which can be predetermined to provide formulation, cured, and ceramic product performance features.

Upon completion of the polymerization reaction the material is transferred into a separation apparatus, e.g., a separation funnel, which has an amount of deionized water that, for example, is from about 1.2× to about 1.5× the mass of the material. This mixture is vigorously stirred for about less than 1 minute and preferably from about 5 to 30 seconds. Once stirred the material is allowed to settle and separate, which may take from about 1 to 2 hours. The polymer is the higher density material and is removed from the vessel. This removed polymer is then dried by either warming in a shallow tray at 90° C. for about two hours; or, preferably, is passed through a wiped film distillation apparatus, to remove any residual water and ethanol. Alternatively, sodium bicarbonate sufficient to buffer the aqueous layer to a pH of about 4 to about 7 is added. It is further understood that other, and commercial, manners of mixing, reacting and separating the polymer from the material may be employed.

Preferably a catalyst is used in the curing process of the polymer precursor formulations from the reaction type process. The same polymers, as used for curing the precursor formulations from the mixing type process can be used. It is noted that, generally unlike the mixing type formulations, a catalyst is not necessarily required to cure a reaction type polymer. Inhibitors may also be used. However, if a catalyst is not used, reaction time and rates will be slower. The curing and the pyrolysis of the cured material from the reaction process is essentially the same as the curing and pyrolysis of the cured material from the mixing process and the reaction blending process.

The reaction type process can be conducted under numerous types of atmospheres and conditions, e.g., air, inert, N₂, Argon, flowing gas, static gas, reduced pressure, ambient pressure, elevated pressure, and combinations and variations of these.

The Reaction Blending Type Process

In the reaction blending type process precursor are reacted to from a precursor formulation, in the absence of a solvent. For example, an embodiment of a reaction blending type process has a precursor formulation that is prepared from MHF and Dicyclopentadiene (DCPD). Using the reactive blending process a MHF/DCPD polymer is created and this polymer is used as a precursor formulation. It can be used alone to form a cured or pyrolized product, or as a precursor in the mixing or reaction processes.

Thus, for example, from about 40 to 90% MHF of known molecular weight and hydride equivalent mass; about 0.20 wt % P01 catalyst; and from about 10 to 60% DCPD with 83% purity, can be used.

P01 is a 2% Pt(0) tetravinylcyclotetrasiloxane complex in tetravinylcyclotetrasiloxane, diluted 20× with tetravinylcyclotetrasiloxane to 0.1% of Pt(0) complex. In this manner 10 ppm Pt is provided for every 1% loading of bulk cat.

In an embodiment of the process, a sealable reaction vessel, with a mixer, can be used for the reaction. The reaction is conducted in the sealed vessel, in air; although other types of atmosphere can be utilized. Preferably, the reaction is conducted at atmospheric pressure, but higher and lower pressures can be utilized. Additionally, the reaction blending type process can be conducted under numerous types of atmospheres and conditions, e.g., air, inert, N₂, Argon, flowing gas, static gas, reduced pressure, ambient pressure, elevated pressure, and combinations and variations of these.

In an embodiment, 850 grams of MHF (85% of total polymer mixture) is added to reaction vessel and heated to about 50° C. Once this temperature is reached the heater is turned off, and 0.20% (by weight of the MHF) of P01 Platinum catalyst is added to the MHF in the reaction vessel. Typically, upon addition of the catalyst, bubbles will form and temperature will initially rise approximately 2-20° C.

When the temperature begins to fall, about 150 g of DCPD (15 wt % of total polymer mixture) is added to the reaction vessel. The temperature may drop an additional amount, e.g., around 5-7° C.

At this point in the reaction process the temperature of the reaction vessel is controlled to, maintain a predetermined temperature profile over time, and to manage the temperature increase that may be accompanied by an exotherm. Preferably, the temperature of the reaction vessel is regulated, monitored and controlled throughout the process.

In an embodiment of the MHF/DCPD embodiment of the reaction process, the temperature profile can be as follows: let temperature reach about 80° C. (may take ˜15-40 min, depending upon the amount of materials present); temperature will then increase and peak at −104° C., as soon as temperature begins to drop, the heater set temperature is increased to 100° C. and the temperature of the reaction mixture is monitored to ensure the polymer temperature stays above 80° C. for a minimum total of about 2 hours and a maximum total of about 4 hours. After 2-4 hours above 80° C., the heater is turn off, and the polymer is cooled to ambient. It being understood that in larger and smaller batches, continuous, semi-continuous, and other type processes the temperature and time profile may be different.

In larger scale, and commercial operations, batch, continuous, and combinations of these, may be used. Industrial factory automation and control systems can be utilized to control the reaction, temperature profiles and other processes during the reaction.

Table A sets forth various embodiments of precursor materials.

TABLE A

| | degree of | Equivalents | Equivalents | Equivalents | Equivalents | Equivalents | Equivalents | | grams/mole |
|---|---|---|---|---|---|---|---|---|---|
| Material Name | polymerization | Si/mole | O/mole | H/mol | Vi/mol | methyl/mole | C/mole | MW | of inyl |
| tetramethylcyclotet | 4 | 4 | 4 | 4 | 0 | 4 | 4 | 240.51 | |
| rasiloxane (D₄) | | | | | | | | | |
| MHF | 33 | 35 | 34 | 33 | 0 | 39 | 39 | 2145.345 | |
| VMF | 5 | 7 | 6 | 0 | 5 | 11 | 21 | 592.959 | 118.59 |
| TV | 4 | 4 | 4 | 0 | 4 | 4 | 12 | 344.52 | 86.13 |
| VT 0200 | 125 | 127 | 126 | 0 | 2 | 254 | 258 | 9451.206 | 4725.60 |
| VT 0020 | 24 | 26 | 25 | 0 | 2 | 52 | 56 | 1965.187 | 982.59 |
| VT 0080 | 79 | 81 | 80 | 0 | 2 | 162 | 166 | 6041.732 | 3020.87 |
| Styrene | | | | | 2 | | | 104.15 | 52.08 |
| Dicyclopentadiene | | | | | 2 | | | 132.2 | 66.10 |
| 1,4-divinylbenzene | | | | | 2 | | | 130.19 | 65.10 |
| isoprene | | | | | 2 | | | 62.12 | 31.06 |
| 1,3 Butadiene | | | | | 2 | | | 54.09 | 27.05 |
| Catalyst 10 ppm Pt | | | | | | | | | |
| Catalyst LP 231 | | | | | | | | | |

In the above table, the “degree of polymerization” is the number of monomer units, or repeat units, that are attached together to from the polymer. “Equivalents_/mol” refers to the molar equivalents. “Grams/mole of vinyl” refers to the amount of a given polymer needed to provide 1 molar equivalent of vinyl functionality. “VMH” refers to methyl vinyl fluid, a linear vinyl material from the ethoxy process, which can be a substitute for TV. The numbers “0200” etc. for VT are the viscosity (e.g., 0200=200 cps) in centipoise for that particular VT.

Curing and Pyrolysis

Precursor formulations, including the polysilocarb precursor formulations from the above types of processes, as well as others, can be cured to form a solid, semi-sold, or plastic like material. Typically, the precursor formulations are spread, shaped, or otherwise formed into a preform, which would include any volumetric structure, or shape, including thin and thick films. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, i.e., all of the reaction has stopped, or the leveling off of the decrease in reactive groups over time, i.e., essentially all of the reaction has stopped). Thus, the material may be cured to varying degrees, depending upon its intended use and purpose. For example, in some situations the end cure and the hard cure may be the same. Curing conditions such as atmosphere and temperature may effect the composition of the cured material.

In multi-layer, or composite structures and shapes, a layer of the polysilocarb material may be cured to varying degrees, for example in a multi-layer embodiment, the layers can be green cured to promote layer adhesion, then finally cured to a hard cure. Each layer in a multi-layer structure can be cured to the same degree of cure, to different degrees of cure, subject to one, two, three or more curing steps, and combinations and variations of these.

The curing may be done at standard ambient temperature and pressure (“SATP”, 1 atmosphere, 25° C.), at temperatures above or below that temperature, at pressures above or below that pressure, and over varying time periods. The curing can be conducted over various heatings, rate of heating, and temperature profiles (e.g., hold times and temperatures, continuous temperature change, cycled temperature change, e.g., heating followed by maintaining, cooling, reheating, etc.). The time for the curing can be from a few seconds (e.g., less than about 1 second, less than 5 seconds), to less than a minute, to minutes, to hours, to days (or potentially longer). The curing may also be conducted in any type of surrounding environment, including for example, gas, liquid, air, water, surfactant containing liquid, inert atmospheres, N₂, Argon, flowing gas (e.g., sweep gas), static gas, reduced O₂ (e.g., an amount of O₂ lower than atmospheric, such as less than 20% O₂, less than 15% O₂, less than 10% 0₂ less than 5% O₂), reduced pressure (e.g., less than atmospheric), elevated pressure (e.g., greater than atmospheric), enriched O₂, (e.g., an amount of O₂ greater than atmospheric), ambient pressure, controlled partial pressure and combinations and variations of these and other processing conditions.

In an embodiment, the curing environment, e.g., the furnace, the atmosphere, the container and combinations and variations of these can have materials that contribute to or effect, for example, the composition, catalysis, stoichiometry, features, performance and combinations and variations of these in the preform, the cured material, the ceramic and the final applications or products.

For high purity materials, the furnace, containers, handling equipment, atmosphere, and other components of the curing apparatus and process are clean, essentially free from, and do not contribute any elements or materials, that would be considered impurities or contaminants, to the cured material.

Preferably, in embodiments of the curing process, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., A degrees/time), hold times, and temperatures) can be utilized.

The cure conditions, e.g., temperature, time, ramp rate, may be dependent upon, and in some embodiments can be predetermined, in whole or in part, by the formulation to match, for example the size of the preform, the shape of the preform, or the mold holding the preform to prevent stress cracking, off gassing, or other phenomena associated with the curing process. Further, the curing conditions may be such as to take advantage of, preferably in a controlled manner, what may have previously been perceived as problems associated with the curing process. Thus, for example, off gassing may be used to create a foam material having either open or closed structure. Similarly, curing conditions can be used to create or control the microstructure and the nanostructure of the material. In general, the curing conditions can be used to affect, control or modify the kinetics and thermodynamics of the process, which can affect morphology, performance, features and functions, among other things.

Upon curing the polysilocarb precursor formulation a cross linking reaction takes place that provides in some embodiments a cross-linked structure having, among other things, by way of example, an —R₁—Si—C—C—Si—O—Si—C—C—Si—R₂— where R₁ and R₂ vary depending upon, and are based upon, the precursors used in the formulation. In an embodiment of the cured materials they may have a cross-linked structure having 3-coordinated silicon centers to another silicon atom, being separated by fewer than 5 atoms between silicon atoms. Although additional other structures and types of cured materials are contemplated. Thus, for example, use of Luperox 231 could yield a structure, from the same monomers, that was —Si—C—C—C—Si—. When other cross linking agents are used, e.g, DCPD and divinyl benzene, the number of carbons atoms between the silicon atoms will be greater than 5 atoms. A generalized formula for some embodiments of the cross-linked, e.g., cured, material, would be —Si—R₃—Si—, where R₃ would be ethyl (from for example a vinyl precursor), propyl (from for example a allyl precursor), dicyclopentane (from for example a DCPD precursor), norbornane (from for example a norbornadiene precursor), diethylbenzene (from for example a divinyl benzene precursor), and others.

During the curing process, some formulations may exhibit an exotherm, i.e., a self heating reaction, that can produce a small amount of heat to assist or drive the curing reaction, or that may produce a large amount of heat that may need to be managed and removed in order to avoid problems, such as stress fractures. During the cure off gassing typically occurs and results in a loss of material, which loss is defined generally by the amount of material remaining, e.g., cure yield. Embodiments of the formulations, cure conditions, and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material typically shrinks, this shrinkage may be, depending upon the formulation, cure conditions, and the nature of the preform shape, and whether the preform is reinforced, filled, neat or unreinforced, from about 20%, less than 20%, less than about 15%, less than about 5%, less than about 1%, less than about 0.5%, less than about 0.25% and smaller.

Curing may be accomplished by any type of heating apparatus, or mechanisms, techniques, or morphologies that has the requisite level of temperature and environmental control. Curing may be accomplished through, for example, heated water baths, electric furnaces, microwaves, gas furnaces, furnaces, forced heated air, towers, spray drying, falling film reactors, fluidized bed reactors, indirect heating elements, direct heating (e.g., heated surfaces, drums, and plates), infrared heating, UV irradiation (light), an RF furnace, in-situ during emulsification via high shear mixing, in-situ during emulsification via ultrasonication, broad spectrum white light, IR light, coherent electromagnetic radiation (e.g. lasers, including visible, UV and IR), and convection heating, to name a few.

In an embodiment, curing may also occur under ambient conditions for an embodiment having a sufficient amount of catalyst.

If pyrolysis is conducted for an embodiment the cured material can be for example heated to about 600° C. to about 2,300° C.; from about 650° C. to about 1,200° C., from about 800° C. to about 1300° C., from about 900° C. to about 1,200° C. and from about 950° C. to 1,150° C. At these temperatures typically all organic structures are either removed or combined with the inorganic constituents to form a ceramic. Typically, at temperatures in the about 650° C. to 1,200° C. range the resulting material is an amorphous glassy ceramic. When heated above about 1,200° C. the material typically may from nano crystalline structures, or micro crystalline structures, such as SiC, Si3N₄, SiCN, β SiC, and above 1,900° C. an a SiC structure may form, and at and above 2,200° C. a SiC is typically formed. The pyrolized, e.g., ceramic materials can be single crystal, polycrystalline, amorphous, and combinations, variations and subgroups of these and other types of morphologies.

The pyrolysis may be conducted under may different heating and environmental conditions, which preferably include thermo control, kinetic control and combinations and variations of these, among other things. For example, the pyrolysis may have various heating ramp rates, heating cycles and environmental conditions. In some embodiments, the temperature may be raised, and held a predetermined temperature, to assist with known transitions (e.g., gassing, volatilization, molecular rearrangements, etc.) and then elevated to the next hold temperature corresponding to the next known transition. The pyrolysis may take place in reducing atmospheres, oxidative atmospheres, low O₂, gas rich (e.g., within or directly adjacent to a flame), inert, N₂, Argon, air, reduced pressure, ambient pressure, elevated pressure, flowing gas (e.g., sweep gas, having a flow rate for example of from about from about 15.0 GHSV (gas hourly space velocity) to about 0.1 GHSV, from about 6.3 GHSV to about 3.1 GHSV, and at about 3.9 GHSV), static gas, and combinations and variations of these.

In some embodiments, upon pyrolization, graphenic, graphitic, amorphous carbon structures and combinations and variations of these are present in the Si—O—C ceramic. A distribution of silicon species, consisting of SiOxCy structures, which result in SiO₄, SiO₃C, SiO₂C₂, SiOC₃, and SiC₄ are formed in varying ratios, arising from the precursor choice and their processing history. Carbon is generally bound between neighboring carbons and/or to a Silicon atom. In general, in the ceramic state, carbon is largely not coordinated to an oxygen atom, thus oxygen is largely coordinated to silicon

The pyrolysis may be conducted in any heating apparatus, that maintains the request temperature and environmental controls. Thus, for example pyrolysis may be done with, pressure furnaces, box furnaces, tube furnaces, crystal-growth furnaces, graphite box furnaces, arc melt furnaces, induction furnaces, kilns, MoSi₂ heating element furnaces, carbon furnaces, vacuum furnaces, gas fired furnaces, electric furnaces, direct heating, indirect heating, fluidized beds, RF furnaces, kilns, tunnel kilns, box kilns, shuttle kilns, coking type apparatus, lasers, microwaves, other electromagnetic radiation, and combinations and variations of these and other heating apparatus and systems that can obtain the request temperatures for pyrolysis.

In embodiments of the polysilocarb derived ceramic materials has any of the amounts of Si, O, C for the total amount of material that are set forth in the Table B.

TABLE B

| | Si | | O | | C | |
|---|---|---|---|---|---|---|
| | Lo | Hi | Lo | Hi | Lo | Hi |
| wt % | 35.00% | 50.00% | 10.00% | 35.00% | 5.00% | 30.00% |
| Mole Ratio | 1.000 | 1.429 | 0.502 | 1.755 | 0.334 | 2.004 |
| Mole % | 15.358% | 63.095% | 8.821% | 56.819% | 6.339% | 57.170% |

In general, embodiments of the pyrolized ceramic polysilocarb materials can have about 20% to about 65% Si, can have about 5% to about 50% O, and can have about 3% to about 55% carbon weight percent. Greater and lesser amounts are also contemplated.

In general, embodiment of the pyrolized ceramic polysilocarb materials can have a mole ratio (based on total Si, O, and C) of about 0.5 to about 2.5 for Si, can have a mole ratio of about 0.2 to about 2.5 for 0, and can have a mole ration of about 0.1 to about 4.5 for C. Greater and lesser amounts are also contemplated.

In general, embodiment of the pyrolized ceramic polysilocarb materials can have a mole % (percentage of total Si, O, and C) of about 13% to about 68% for Si, can have a mole % of about 6% to about 60% for 0, and can have a mole % of about 4% to about 75% for C. Greater and lesser amounts are also contemplated.

The type of carbon present in embodiments of the polysilocarb derived ceramic pigments can be free carbon, (e.g., turbostratic, amorphous, graphenic, graphitic forms of carbon) and carbon that is bound to silicon. Embodiments of ceramic polysilocarb materials having free carbon and silicon-bound-carbon (Si—C) are set forth in Table C. Greater and lesser amounts and different percentages of free carbon and silicon-bound-carbon are also contemplated.

TABLE C

| Embodiment | % Free Carbon | % Si—C type |
|---|---|---|
| 1 | 64.86 | 35.14 |
| 2 | 63.16 | 36.85 |
| 3 | 67.02 | 32.98 |
| 4 | 58.59 | 41.41 |
| 5 | 68.34 | 31.66 |
| 6 | 69.18 | 30.82 |
| 7 | 65.66 | 34.44 |
| 8 | 72.74 | 27.26 |
| 9 | 72.46 | 27.54 |
| 10 | 78.56 | 21.44 |

Generally, embodiments of polysilocarb derived ceramic materials can have from about 30% free carbon to about 70% free carbon, from about 20% free carbon to about 80% free carbon, and from about 10% free carbon to about 90% free carbon, and from about 30% Si—C bonded carbon to about 70% Si—C bonded carbon, from about 20% Si—C bonded carbon to about 80% Si—C bonded carbon, and from about 10% Si—C bonded carbon to about 90% Si—C bonded carbon. Greater and lesser amounts are also contemplated.

Metals and Metal Complexes

By way of example, metals and metal complexes that can be used as fill material would include Cyclopentadienyl compounds of the transition metals can be utilized. Cyclopentadienyl compounds of the transition metals can be organized into two classes: Bis-cyclopentadienyl complexes; and Mono-cyclopentadienyl complexes. Cyclopentadienyl complexes can include C₅H₅, C₅Me₅, C₅H₄Me, CH₅R₅ (where R=Me, Et, Propyl, i-Propyl, butyl, Isobutyl, Sec-butyl). In either of these cases Si can be directly bonded to the Cyclopentadienyl ligand or the Si center can be attached to an alkyl chain, which in turn is attached to the Cyclopentadienyl ligand.

Cyclopentadienyl complexes, that can be utilized with precursor formulations and in products, can include: bis-cyclopentadienyl metal complexes of first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum); Lanthanide series (La, Ce, Pr, Nd, Pm, Sm, Eu, Gd, Tb, Dy, Ho); and Actinide series (Ac, Th, Pa, U, Np).

Monocyclopentadienyl complexes may also be utilized to provide metal functionality to precursor formulations and would include monocyclopentadienyl complexes of: first row transition metals (Titanium, Vanadium, Chromium, Iron, Cobalt, Nickel); second row transition metals (Zirconium, Molybdenum, Ruthenium, Rhodium, Palladium); third row transition metals (Hafnium, Tantalum, Tungsten, Iridium, Osmium, Platinum) when preferably stabilized with proper ligands, (for instance Chloride or Carbonyl).

Alkyl complexes of metals may also be used to provide metal functionality to precursor formulations and products. In these alkyl complexes the Si center has an alkyl group (ethyl, propyl, butyl, vinyl, propenyl, butenyl) which can bond to transition metal direct through a sigma bond. Further, this would be more common with later transition metals such as Pd, Rh, Pt, Ir.

Coordination complexes of metals may also be used to provide metal functionality to precursor formulations and products. In these coordination complexes the Si center has an unsaturated alkyl group (vinyl, propenyl, butenyl, acetylene, butadienyl) which can bond to carbonyl complexes or ene complexes of Cr, Mo, W, Mn, Re, Fe, Ru, Os, Co, Rh, Ir, Ni. The Si center may also be attached to a phenyl, substituted phenyl or other aryl compound (pyridine, pyrimidine) and the phenyl or aryl group can displace carbonyls on the metal centers.

Metal alkoxides may also be used to provide metal functionality to precursor formulations and products. Metal alkoxide compounds can be mixed with the silicon precursor compounds and then treated with hydroxide to form the oxides at the same time as the polymer, copolymerizes. This can also be done with metal halides and metal amides. Preferably, this may be done using early transition metals along with Aluminum, Gallium and Indium, later transition metals: Fe, Mn, Cu, and alkaline earth metals: Ca, Sr, Ba, Mg.

Compounds where Si is directly bonded to a metal center which is stabilized by halide or organic groups may also be utilized to provide metal functionality to precursor formulations and products.

Additionally, it should be understood that the metal and metal complexes may be the continuous phase after pyrolysis, or subsequent heat treatment. Formulations can be specifically designed to react with selected metals to in situ form metal carbides, oxides and other metal compounds, generally known as cermets (e.g., ceramic metallic compounds). The formulations can be reacted with selected metals to form in situ compounds such as mullite, alumino silicate, and others. The amount of metal relative to the amount of silica in the formulation or end product can be from about 0.1 mole % to 99.9 mole %, about 1 mole % or greater, about 10 mole % or greater, and about 20 mole percent or greater. The forgoing use of metals with the present precursor formulas can be used to control and provide predetermined stoichiometries.

### HEADINGS AND EMBODIMENTS

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of formulations, compositions, articles, plastics, ceramics, materials, parts, uses, applications, equipment, methods, activities, and operations set forth in this specification may be used for various other fields and for various other activities, uses and embodiments. Additionally, these embodiments, for example, may be used with: existing systems, articles, compositions, plastics, ceramics, operations or activities; may be used with systems, articles, compositions, plastics, ceramics, operations or activities that may be developed in the future; and with such systems, articles, compositions, plastics, ceramics, operations or activities that may be modified, in-part, based on the teachings of this specification. Further, the various embodiments and examples set forth in this specification may be used with each other, in whole or in part, and in different and various combinations. Thus, for example, the configurations provided in the various embodiments and examples of this specification may be used with each other; and the scope of protection afforded the present inventions should not be limited to a particular embodiment, example, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A polysicocarb ceramic effects pigment, the pigment comprising:
a. an effect layer, a polysilocarb derived ceramic base and an optical interface between the effect layer and the polysilocarb derived ceramic base;
b. the effect layer defining a thickness, a reflective effect, and a refractive effect, wherein the reflective effect and refractive effect are different;
c. the polysilocarb derived ceramic base consisting essentially of carbon, oxygen and silicon;
d. the polysicocarb derived ceramic base defining a thickness, an absorption coefficient, and a percentage light absorption;
e. wherein the refractive effect interacts across the optical interface with the polysilocarb base to define a secondary reflective effect.

2. The pigment of claim 1, wherein the secondary reflective effect is predetermined and controlled based in part upon the carbon content of the base.

3. The pigment of claim 1, wherein the absorption coefficient of the base is from about 1,000 to about 20,000 1/cm.

4. (canceled)

5. The pigment of claim 1, wherein the thickness of the base is from about 0.2 μm to about 2 μm.

6. The pigment of claim 1, wherein the thickness of the base is from about 0.5 μm to about 2.5 μm.

7. (canceled)

8. The pigment of claim 1, wherein the base has a percentage light absorption from about 40% to about 100%.

9. (canceled)

10. The pigment of claim 1, wherein the base has a percentage light absorption from about 60% to about 80%.

11. (canceled)

12. (canceled)

13. (canceled)

14. (canceled)

15. (canceled)

16. (canceled)

17. (canceled)

18. (canceled)

19. (canceled)

20. The pigment of claim 1, wherein the effect layer is integral with the base.

21. The pigment of claim 1, wherein the secondary reflective effect is selected from the group consisting of pearl, gold, red, green and blue.

22. The pigment of claim 2, wherein the secondary reflective effect is selected from the group consisting of pearl, gold, red, green and blue.

23. A polysicocarb ceramic magnetic effects pigment, the pigment comprising:
a. an effect layer, a polysilocarb derived ceramic base and an optical interface between the effect layer and the polysilocarb derived ceramic base;
b. the effect layer defining a thickness, a reflective effect, and a refractive effect, wherein the reflective effect and refractive effect are different;
c. the polysilocarb derived ceramic base comprising magnetite, carbon, oxygen and silicon;
d. the polysicocarb derived ceramic base defining a thickness, an absorption coefficient, and a percentage light absorption;
e. wherein the refractive effect interacts across the optical interface with the polysilocarb base to define a secondary reflective effect.

24. The pigment of claim 23, wherein the secondary reflective effect is selected from the group consisting of pearl, gold, red, green and blue.

25. The pigment of claim 23, wherein the secondary reflective effect is predetermined and controlled based in part upon the carbon content of the base.

26. (canceled)

27. The pigment of claim 23, wherein the absorption coefficient of the base is from about 5,000 to about 15,000 1/cm.

28. (canceled)

29. (canceled)

30. The pigment of claim 23, wherein the base has a percentage light absorption from about 40% to about 100%.

31. (canceled)

32. (canceled)

33. (canceled)

34. The pigment of claim 23, wherein the base has a percentage light absorption from about 60% to about 98%.

35. The pigment of claim 23, wherein the effect layer comprises a material selected from the group consisting of SiO₂, TiO₂, FeO₂, Fe₂O₃, Fe₃O₄, Cr₂O₂, and (Sn, Sb)O₂.

36. The pigment of claim 23, wherein the reflective effect comprises an effect selected from the group consisting of pearl, gold, red, green and blue.

37. (canceled)

38. (canceled)

39. The pigment of claim 23, wherein the effect layer is integral with the base.

40. A polysicocarb ceramic magnetic effects pigment, the pigment comprising:
a. a polysilocarb derived ceramic base;
b. the polysilocarb derived ceramic base consisting essentially of magnetite, carbon, oxygen and silicon; and,
c. the polysicocarb derived ceramic base defining a thickness, an absorption coefficient, and a percentage light absorption.

41-45. (canceled)
